(19) United States
(12) Patent Application Publication
(10) Pub. No.: US 2004/0078172 A1
(43) Pub. Date: Apr. 22, 2004

(54) Structured system for the planning, integration, analysis and management of new product development on a real-time, enterprise-wide basis

(76) Inventors: Richard S. Moore, Sudbury, MA (US); Ralph G. Brown, Stow, MA (US); Jack D. Brown JR., Shrewsbury, MA (US)

Correspondence Address: Mark J. Pandiscio, Pandiscio & Pandiscio, P.C., 470 Toten Pond Road, Waltham, MA, 02451-1914, US

(21) Appl. No.: 10/439,199

(22) Filed: May 15, 2003

Related U.S. Application Data
(63) Continuation-in-part of application No. 09/888,355, filed on Jun. 22, 2001.
(63) Continuation-in-part of application No. 10/137,069, filed on Apr. 30, 2002.
(63) Continuation-in-part of application No. 10/136,800, filed on Apr. 30, 2002.
(60) Provisional application No. 60/380,668, filed on May 15, 2002.

(51) Int. Cl. G06F 17/50

(52) U.S. Cl. 703/1

(57) ABSTRACT

A novel structured system for the planning, integration, analysis and management of new product development on a real-time, enterprise-wide basis.

### REFERENCE TO PENDING PRIOR PATENT APPLICATIONS

This is a continuation-in-part of: (1) pending prior U.S. patent application Ser. No. 09/888,355, filed Jun. 22, 2001 by Anne T. Donelan et al. for STRUCTURED SYSTEM FOR THE PLANNING, INTEGRATION, ANALYSIS AND MANAGEMENT OF NEW PRODUCT DEVELOPMENT ON A REAL-TIME, ENTERPRISE-WIDE BASIS (Attorney's Docket No. IDE-1), (2) pending prior U.S. patent application Ser. No. 10/137,069, filed Apr. 30, 2002 by Richard S. Moore et al. for STRUCTURED SYSTEM FOR THE PLANNING, INTEGRATION, ANALYSIS AND MANAGEMENT OF NEW PRODUCT DEVELOPMENT ON A REAL-TIME, ENTERPRISE-WIDE BASIS (Attorney's Docket No. IDE-2), and (3) pending prior U.S. patent application Ser. No. 10/136,800, filed Apr. 30, 2002 by Richard S. Moore et al. for STRUCTURED SYSTEM FOR THE PLANNING, INTEGRATION, ANALYSIS AND MANAGEMENT OF NEW PRODUCT DEVELOPMENT ON A REAL-TIME, ENTERPRISE-WIDE BASIS (Attorney's Docket No. IDE-3).

This patent application also claims benefit of pending prior U.S. Provisional Patent Application Serial No. 60/380,668, filed May 15, 2002 by Richard S. Moore et al. for STRUCTURED SYSTEM FOR THE PLANNING, INTEGRATION, ANALYSIS AND MANAGEMENT OF NEW PRODUCT DEVELOPMENT ON A REAL-TIME, ENTERPRISE-WIDE BASIS (Attorney's Docket No. IDE-4 PROV).

The four (4) above-identified patent applications are hereby incorporated herein by reference.

### FIELD OF THE INVENTION

This invention relates to the planning, integration, analysis and management of complex systems in general, and more particularly to structured systems for the planning, integration, analysis and management of such complex systems.

### BACKGROUND OF THE INVENTION

Many complex systems exist in the real world. For example, there are complex natural systems (e.g., physical and biological systems) and complex man-made systems (e.g., social and industrial systems).

It has generally been found that such complex systems can be better understood and, in some cases, better managed, by using a so-called structured approach or methodology.

The present invention is directed to one such complex system, i.e., new product development (also sometimes referred to as “Development Chain Management”), and to a structured system for the planning, integration, analysis and management of the same.

Currently, relatively few tools exist for conducting a structured integration of new product development processes. In addition, the few tools which do exist are generally limited to (1) “stand-alone” tools which are designed solely for the analysis of a single new product development project, and (2) “stand-alone” tools which are designed solely for the analysis of a strategic portfolio, and (3) “stand-alone” tools which are designed solely for the analysis of resources, but none of them are designed for integrating all of the foregoing.

Unfortunately, however, many large enterprises must simultaneously plan and execute numerous new product development projects. These planned and in-progress projects must compete with one another for the limited resources available to the enterprise, e.g., people, facilities, machines, etc. As enterprises have become more and more sophisticated, they have begun to look at how they can coordinate their numerous new product development projects so as to balance new product yield, resource consumption, and business strategy. This typically means that enterprises wish to evaluate their numerous new product development projects on an enterprise-wide basis, rather than on just a single project basis, so as to ensure optimal planning, integration, analysis and management.

Unfortunately, attempts to utilize existing, “stand-alone” new product development tools on a large-scale, enterprise-wide basis have proven unsatisfactory. More particularly, using “stand-alone” tools to simultaneously evaluate multiple new product development projects across an entire enterprise tends to overwhelm the tools, leading to inconsistent standards and information reporting, and making it impossible to provide adequate information on a real-time basis. Thus, attempts to utilize existing “stand-alone” tools on an enterprise-wide basis typically results in questionable data delivered on an untimely basis.

### OBJECTS OF THE INVENTION

Accordingly, a primary object of the present invention is to provide a novel structured system for the planning, integration, analysis and management of new product development on a real-time, enterprise-wide basis.

Another object of the present invention is to provide a novel structured system for the planning, integration, analysis and management of new product development on a real-time, enterprise-wide basis which can simultaneously accommodate the needs of enterprise management (e.g., executive review committees or portfolio managers, etc.), project managers and resource managers.

### SUMMARY OF THE INVENTION

These and other objects are addressed by the present invention, which comprises a novel structured system for the planning, integration, analysis and management of new product development on a real-time, enterprise-wide basis.

In one form of the present invention, there is provided a computer program product embodied on a computer-readable medium and comprising code that, when executed, causes the computer to perform the following: a configuration of a structured system for the planning, integration, analysis and management of new product development on a real-time, enterprise-wide basis at the initiation of said computer code, said system comprising: a portfolio planning and management component; a project planning and management component; a resource planning and management component; a process planning and management component; and a managed parent construct defining a flexible relationship between parent data and child data in at least one of said components; a modification of said child data in one of said components; and an automatic reconfiguration of each of said other components to conform with said modified one of said components without automatic modification to said parent data.

In another form of the present invention, there is provided a computer program product embodied on a computer-readable medium and comprising code that, when executed, causes the computer to perform the following: a configuration of a structured system for the planning, integration, analysis and management of new product development on a real-time, enterprise-wide basis at the initiation of said computer code, said system comprising: a portfolio planning and management component; a project planning and management component; a resource planning and management component; and a constraint construct selectively defining at least one of a start constraint and a finish constraint for a system element of at least one of said components; a modification of one of said components without automatic modification of the system element beyond said start constraint and said finish constraint; and an automatic reconfiguration of each of said other components without automatic modification of the system element beyond said start constraint and said finish constraint.

In another form of the present invention, there is provided a computer program product embodied on a computer-readable medium and comprising code that, when executed, causes the computer to perform the following: a configuration of a structured system for the planning, integration, analysis and management of new product development on a real-time, enterprise-wide basis at the initiation of said computer code, said system comprising: a portfolio planning and management component; a project planning and management component; a resource planning and management component; a process planning and management component; and an anchored element construct defining a disconnected relationship between parent data and child data in at least one of the components, a system element comprising at least a portion of one of said parent data and said child data in at least one of the components, and selectively configurable restriction parameters for setting a given start time and a given finish time for said system element; a modification of at least one of said components; and an automatic reconfiguration of each of said other components to conform with said modified one of said components without automatic modification to said anchored system element.

In another form of the present invention, there is provided a computer program product embodied on a computer-readable medium and comprising code that, when executed, causes the computer to perform the following: a configuration of a structured system for the planning, integration, analysis and management of new product development on a real-time, enterprise-wide basis at the initiation of said computer code, said system comprising: a portfolio planning and management component; a project planning and management component; a resource planning and management component; a process planning and management component; and a dependent system element structure, wherein at least a given start time and a given end time of an action of a first system element in at least one of said components is dependent on at least one of a given start time and a given end time of another action of a second system element in at least one of said components; a modification of one of said components; and an automatic reconfiguration of each of said other components to conform with said modified one of said components, and an automatic reconfiguration of said action of said first system element to conform with said another action of said second system element.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like elements and further wherein:

FIG. 1 is a schematic diagram illustrating the general architecture of the novel system of the present invention;

FIG. 2 is a schematic diagram illustrating the general relationship between an enterprise and its portfolios and projects and resources;

FIG. 3 is a schematic diagram illustrating various aspects of a project;

FIG. 4 is a schematic diagram illustrating various aspects of resources;

FIG. 5 is a schematic diagram illustrating various aspects of resource groups;

FIG. 6 is a schematic diagram illustrating various aspects of skill families;

FIG. 7 is a flowchart illustrating a preferred methodology for the system's process planning and management component;

FIG. 8 is a schematic diagram illustrating a common relationship between planning and resources;

FIG. 9 is a schematic diagram illustrating resource configuration and assignment;

FIG. 9A is a schematic diagram illustrating the assignment of resource capacity to projects;

FIG. 10 is a schematic diagram illustrating a process hierarchy;

FIG. 11 is a schematic diagram illustrating aspects of the reconciliation engine's scheduling feature;

FIG. 12 is a schematic diagram and two associated charts illustrating aspects of the reconciliation engine's resource feature;

FIG. 13 illustrates a general methodology for calculating capacity in various situations in the system;

FIG. 14 is a schematic diagram illustrating how external users may be prevented from gaining access to the information contained in the system;

FIG. 15 is a table showing how internal users may be authorized for different types of access into the system;

FIG. 16 is a schematic diagram illustrating one way in which an external user may be given limited access to the information contained in the system;

FIG. 17 is a schematic diagram illustrating another way in which an external user may be given limited access to the information contained in the system;

FIG. 18 is a schematic diagram illustrating still another way in which an external user may be given limited access to the information contained in the system;

FIG. 19 is a table showing how external users may be authorized for different types of access into the system;

FIG. 20 is a schematic diagram illustrating how two different enterprises may share common elements of a structured development process;

FIGS. 21-25, 27 and 28 are screen displays illustrating various aspects of Program Data Objects (PDO's);

FIG. 26 is a schematic diagram illustrating various aspects of PDO assignments;

FIG. 29 is a schematic diagram illustrating various aspects of PDO assignments;

FIGS. 30-34 are schematic illustrations showing various aspects of parents and children;

FIG. 35 is a schematic illustration showing various aspects of date constraints and anchors; and

FIGS. 36 and 37 are various illustrations showing various aspects of dependencies and float.

### DETAILED DESCRIPTION OF THE INVENTION

### System Overview

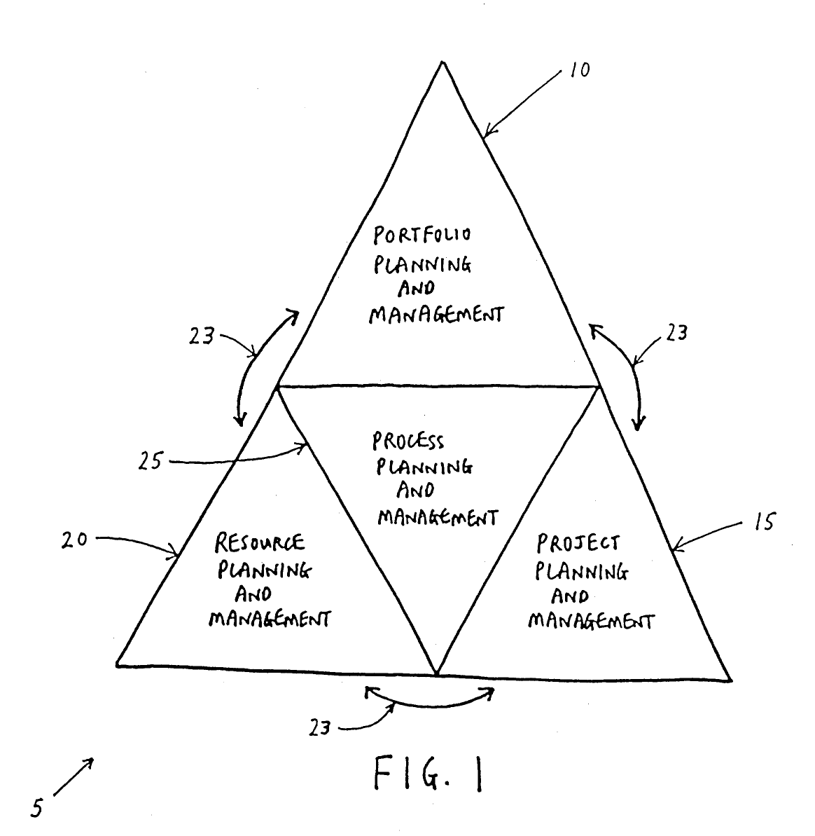

Looking first at FIG. 1, there is shown a diagram which schematically illustrates the general architecture of the novel structured system of the present invention. More particularly, the present invention comprises a novel structured system 5 for the planning, integration, analysis and management of new product development on a real-time, enterprise-wide basis. System 5 is adapted to coordinate the relationship between three basic system components: (1) a portfolio planning and management component 10; (2) a project planning and management component 15; and (3) a resource planning and management component 20. These three basic system components, and the manner in which they interact with one another, provide the overall structured construct for the planning, integration, analysis and management of new product development on a real-time, enterprise-wide basis.

As shown by the three arrows 23 in FIG. 1, there is an interaction between project planning and management component 15 and portfolio planning and management component 10; and there is an interaction between resource planning and management component 20 and portfolio planning and management component 10; and there is an interaction between project planning and management component 15 and resource planning and management component 20. In other words, there is a dynamic relationship between the planning and management of a specific project and the planning and management of a portfolio to which that project belongs; and there is a dynamic relationship between the planning and management of resources and the planning and management of a portfolio to which those resources are associated; and there is a dynamic relationship between the planning and management of a project and the planning and management of the resources which are utilized by that project.

In accordance with the present invention, portfolio planning and management component 10, project planning and management component 15, and resource planning and management component 20 are coordinated with one another through a fourth basic system component, which is a process planning and management component 25.

Significantly, all four of the system's basic components (i.e., portfolio planning and management component 10, project planning and management component 15, resource planning and management component 20, and process planning and management component 25) are dynamic elements, in the sense that they are intended to be configured at the initiation of the system, but are capable of being, and in fact are intended to be, adjusted or modified during the life of the system, with the adjustments or modifications flowing appropriately through all of the elements of the single structured system.

In one preferred implementation of the present invention, system 5 is embodied in software developed by Integrated Development Enterprise, Inc. of Concord, Massachusetts under the name IDweb™. Further details regarding system 5 are disclosed below or are disclosed in the product brief for IDweb™ (entitled “IDweb DEVELOPMENT CHAIN MANAGEMENT SOLUTION”), a copy of which is attached as APPENDIX A, or are disclosed in the product brochure for IDweb™ (entitled “IDweb the profit integrated from the solution for e-management development of product chain development management”), a copy of which is attached as APPENDIX B, or are disclosed in a product presentation for IDweb™ (entitled “PRODUCT PRESENTATION FOR IDweb”), a copy of which is attached as APPENDIX C.

### Portfolio Planning and Management Component 10

Portfolio planning and management component 10 relates to the high level planning, integration, analysis and management of projects and resources on an enterprise-wide basis as viewed in the context of an articulated portfolio strategy. In other words, portfolio planning and management component 10 is the portion of the system that is used by enterprise management to plan, analyze and oversee the various projects and resources of the enterprise.

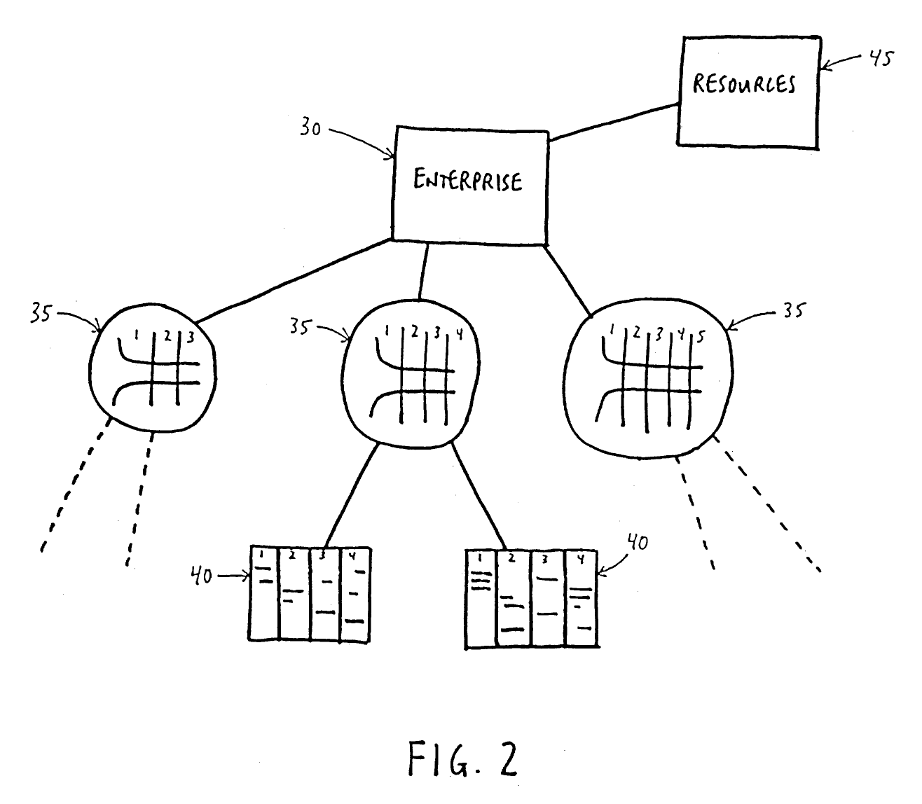

In accordance with the present invention, and looking now at FIG. 2, an enterprise 30 can be viewed, schematically, as consisting of one or more portfolios 35, wherein each portfolio 35 comprises one or more specific projects 40 which are to be planned, analyzed and reviewed on a common standard. Enterprise 30 typically has a limited supply of resources 45 with which to carry out its various projects 40.

In one preferred implementation of the present invention, portfolio planning and management component 10 is embodied in software developed by Integrated Development Enterprise, Inc. of Concord, Massachusetts under the name IDpipeline™. As will hereinafter be discussed in further detail, the IDpipeline™ software aggregates system data for management and presents that data to management in a visually compelling way. Depending on the type of data which is to be presented, the data could be presented in a pipeline diagram, a pie chart, a bar chart, etc.

Further details regarding portfolio planning and management component 10 are disclosed below or are disclosed in the user manual for IDpipeline™, a copy of which is attached as APPENDIX D.

### Project Planning and Management Component 15

Project planning and management component 15 relates to the planning and management of a single, specific new product development project as viewed in the context of a larger enterprise. In other words, project planning and management component 15 is the portion of the system which is used by specific project managers to plan, analyze, review and implement various aspects of their specific project.

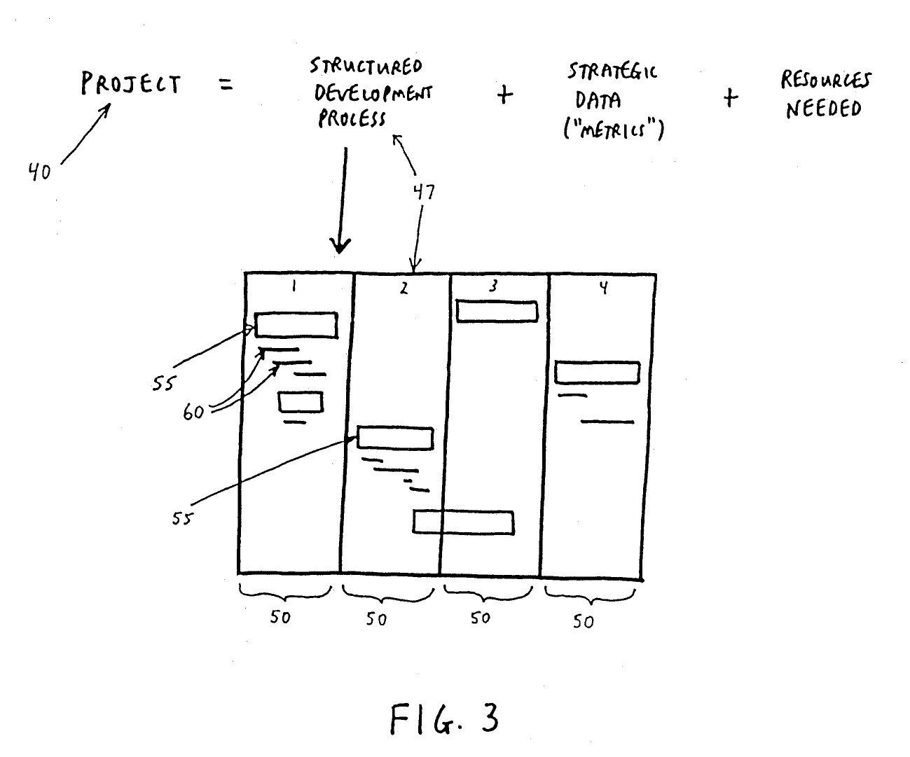

In accordance with the present invention, and looking now at FIG. 3, a specific project 40 can be viewed, schematically, as consisting of a structured development process 47 consisting of one or more phases 50, plus the strategic data (or “metrics”) associated with that project, plus the resources needed to implement that project.

The project's phases 50 may also include a plurality of subordinate steps 55, each of which may include one or more subordinate tasks 60, etc. Furthermore, the system is configured so that deliverables (e.g., documents, prototypes, etc.) and resources can be attached to elements of the structured development process (i.e., to projects, phases, steps, tasks, etc.).

Examples of the strategic data (“metrics”) associated with a given project might include items like risk assessment, return on investment, attractiveness assessment, predicted project revenue, predicted cost of executing a project, etc.; essentially, any information associated with assessing the desirability of the project to the enterprise.

In one preferred implementation of the present invention, project planning and management component 15 is embodied in software developed by Integrated Development Enterprise, Inc. of Concord, Mass. under the name IDprojectview™. As will hereinafter be discussed in further detail, the IDprojectview™ software provides the project manager with an interface for entering the appropriate data for their particular project into the system. In addition, the IDprojectview™ software provides the project manager with an intelligent viewer for reviewing pertinent information regarding the project. More particularly, in IDprojectview™, the intelligent viewer is configured so as to act in two ways: (1) it brings to the attention of the project manager information which has been previously identified as being important to the project manager, and (2) it identifies deviations from the project plan. In addition, IDprojectview™ permits the project manager to conduct localized scenario evaluations (i.e., to conduct limited “what ifs”) in the context of the entire system, taking into account the existence of projects other than their own. For example, IDprojectview™ allows the project manager to determine the effect, with respect to other projects and available resources, of pushing out a phase boundary or other dates by a certain amount of time.

Further details regarding project planning and management component 15 are disclosed below or are disclosed in the user manual for IDprojectview™, a copy of which is attached as APPENDIX E.

### Resource Planning and Management Component 20

Resource planning and management component 20 relates to the coordination of resources within the enterprise and the utilization those resources by specific projects. In other words, resource planning and management component 20 is the portion of the system which is used by resource planners to plan and manage the utilization of resources across the enterprise.

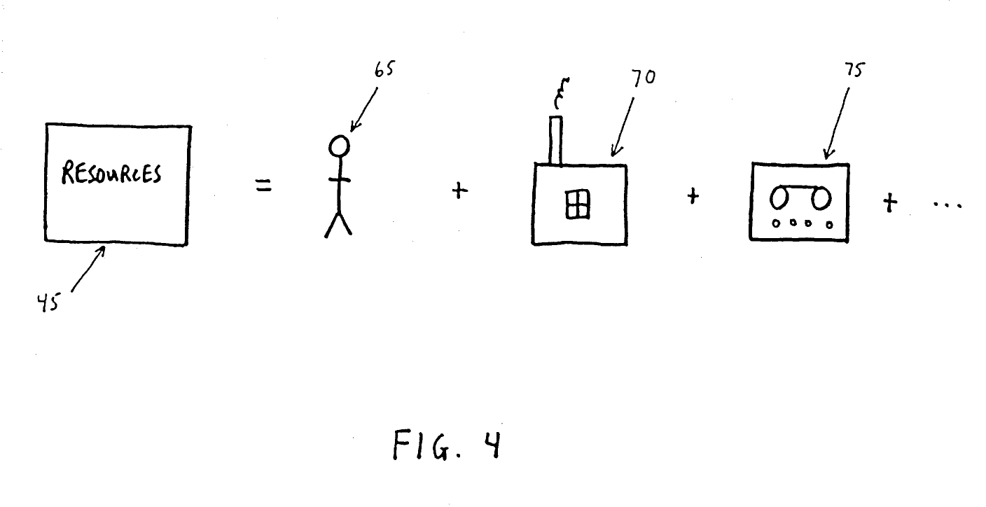

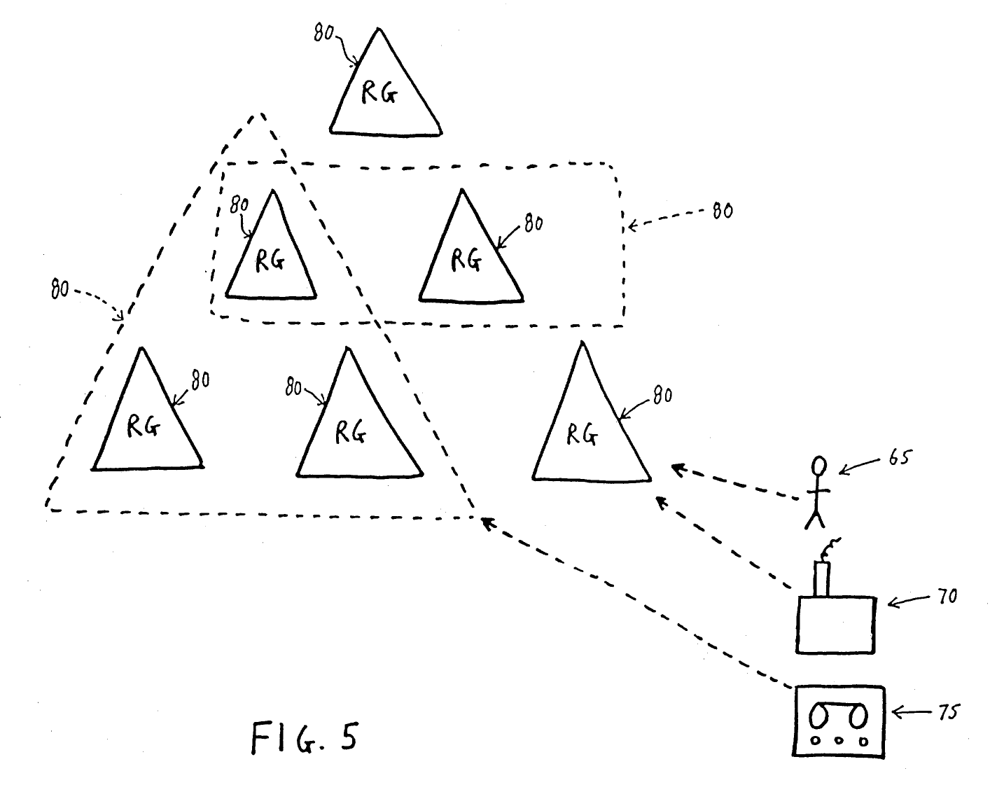

In accordance with the present invention, and looking now at FIG. 4, the enterprise's resources 45 can be considered to be made up of people 65, facilities 70, equipment 75, etc., all typically measured in terms of “FTE”, or “full time equivalents”.

Also in accordance with the present invention, and looking now at FIG. 5, the enterprise can create various resource groups 80, which may in turn include other resource groups 80, whereby to effectively create a resource group hierarchy, for establishing how that enterprise organizes its resources. These resource groups can then be given “capacity” by associating specific resources with specific resource groups, as will hereinafter be discussed in further detail.

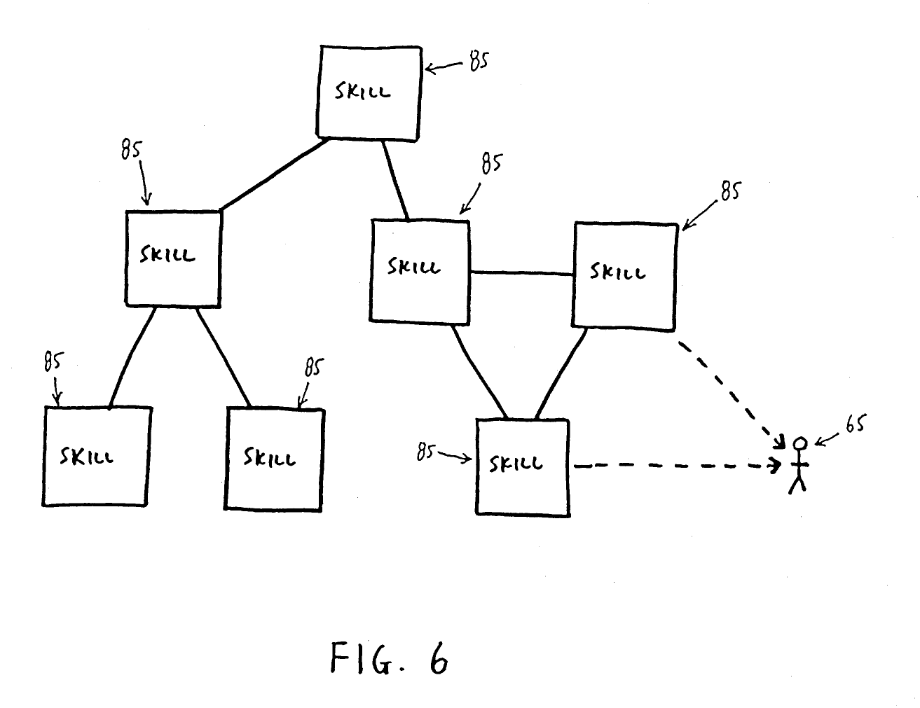

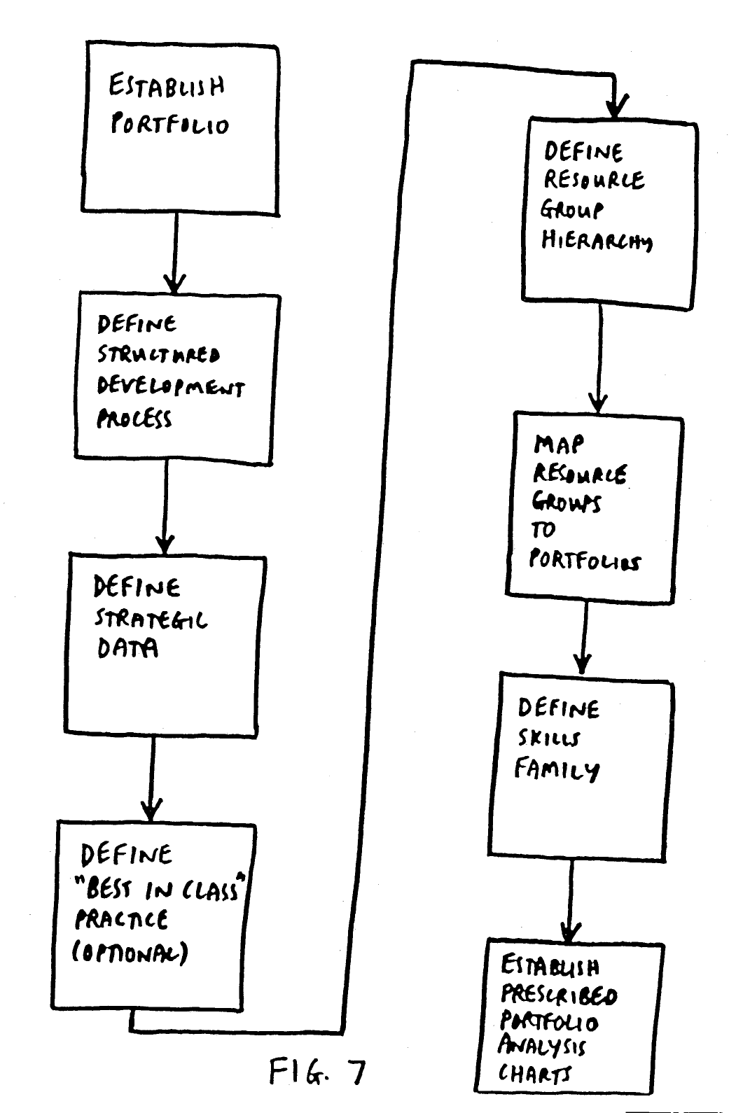

Also in accordance with the present invention, and looking now at FIG. 6, the enterprise can also create various skill categories 85, which may in turn be associated with other skill categories 85, so as to create a so-called skill family, for facilitating how the enterprise looks at the attributes of its resources. These skill families can then be associated with specific resources, as will also hereinafter be discussed in further detail below.

In one preferred implementation of the present invention, resource planning and management component 20 is embodied in software developed by Integrated Development Enterprise, Inc. of Concord, Massachusetts under the name IDresource™.

Further details regarding resource planning and management component 20 are disclosed below or in the user manual for IDresource™, a copy of which is attached as APPENDIX F.

### Process Planning and Management Component 25 (“Process Mapper”)

As noted above, portfolio planning and management component 10, project planning and management component 15 and resource planning and management component 20 are integrated and coordinated with one another in the present system through the use of process planning and management component 25. More particularly, process planning and management component 25 is the portion of the system which is used by process planners to coordinate the other portions of the system, i.e., portfolio planning and management component 10, project planning and management component 15 and resource planning and management component 20.

In accordance with the present invention, and looking now at the flowchart shown in FIG. 7, process planning and management component 25 preferably utilizes a specific methodology to establish the constructs which integrate and coordinate the interaction of the three other basic components of the system, i.e., portfolio planning and management component 10, project planning and management component 15 and resource planning and management component 20. More particularly, this preferred methodology is as follows:

(1) establish the portfolio (i.e., establish a definition for a group of projects which will be measured against a common set of standards and, therefor, dealt with on a portfolio-wide basis;

(2) define the structured development process 47 (FIG. 3) which is to be used for the various projects in that portfolio—in particular, this portion of the process consists of defining at least the phases required of all projects in that portfolio;

(3) defining the strategic data (i.e., the “metrics”) which is to be tracked for all of the projects in a given portfolio;

(4) optionally, defining a “best in class” practice, which acts as a sort of template for new projects, whereby to steer each new project toward the best practices previously identified by the organization—this process can involve defining specific subordinate steps and specific subordinate tasks which will be involved in projects in the portfolio or, alternatively, it can involve defining an entire project template (optionally including subordinate steps and subordinate tasks);

(5) defining the resource group hierarchy (which could be, if desired, flat);

(6) mapping the resource groups to the portfolios;

(7) defining the skills family and, optionally, to the extent that “best in class” practice was defined in Step 4, defining specific resources for use in the “best in class” practice; and

(8) establishing the prescribed portfolio analysis charts which will used by management to review the portfolio.

If desired, Step 8 can be conducted earlier, e.g., any time after Step 3. In fact, Steps 3 through 8 can vary in sequence, provided, however, that Step 5 must precede Step 6.

In one preferred implementation of the present invention, process planning and management component 25 is embodied in software developed by Integrated Development Enterprise, Inc. of Concord, Massachusetts under the name IDprocess™. IDprocess™ effectively walks the process planner through a process set-up (also known as the “Process Mapper”) so as to appropriately configure the system.

Further details regarding process planning and management component 25 are disclosed below or in the user manual for IDprocess™, a copy of which is attached as APPENDIX G.

### Resource Configuration and Assignment (“Resource Evaluator”)

As noted above, the process planning and management component 25 is used to define the resource group hierarchy, map the resource groups to the portfolios, and define the skills family. These steps, in combination with others, are commonly referred to as “resource configuration and assignment”.

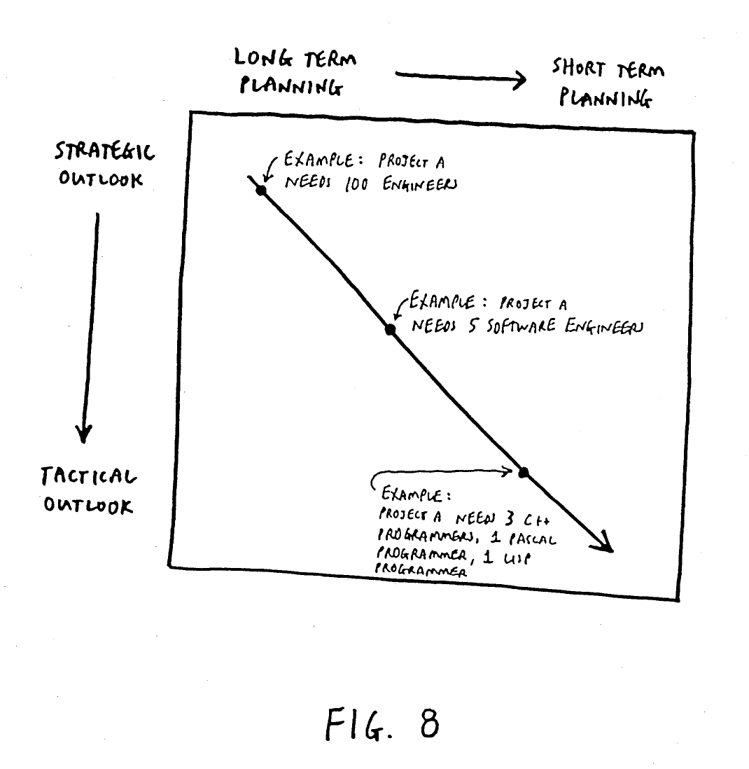

More particularly, and looking now at FIG. 8, there is schematically illustrated a common relationship between planning and resources. In essence, this diagram reflects the fact that planning typically begins on a long-term, strategic basis and evolves into a short term, tactical basis. During this evolution, resources are typically thought of in an increasingly specific manner.

By way of example but not limitation, during the strategic planning phase, a particular project might only anticipate that it needs a hundred engineers; at a later stage in the process, that same project might determine that it needs five engineers; and at a still later stage in the process, that same project might determine that it needs three C++ programmers, one Pascal programmer, and one LISP programmer.

By way of further example but not limitation, during the strategic planning phase, the enterprise might only anticipate that it needs five hundred engineers; at a later stage in the process, the enterprise might determine that a particular resource group needs ten software engineers; and at a still later stage in the process, the enterprise might determine that this same resource group needs six C++ programmers, one Pascal programmer, one Perl programmer, and one LISP programmer.

In this respect it should also be appreciated that at the strategic level, it may be desired to reserve general capacity, without reference to a specific resource element (e.g., to reserve 100 engineers); however, at the tactical level, it may be desired to assign specific capacity in the form of a specific resource (e.g., to assign engineer Harry Smith). The system is configured so as to smoothly accommodate this transition from strategic planning to tactical implementation.

The present system is able to accommodate this evolutionary, increasingly-specific process of identifying resource needs, and assigning resource capacity, due to the unique way in which resource groups, skills and resources are configured in the present system.

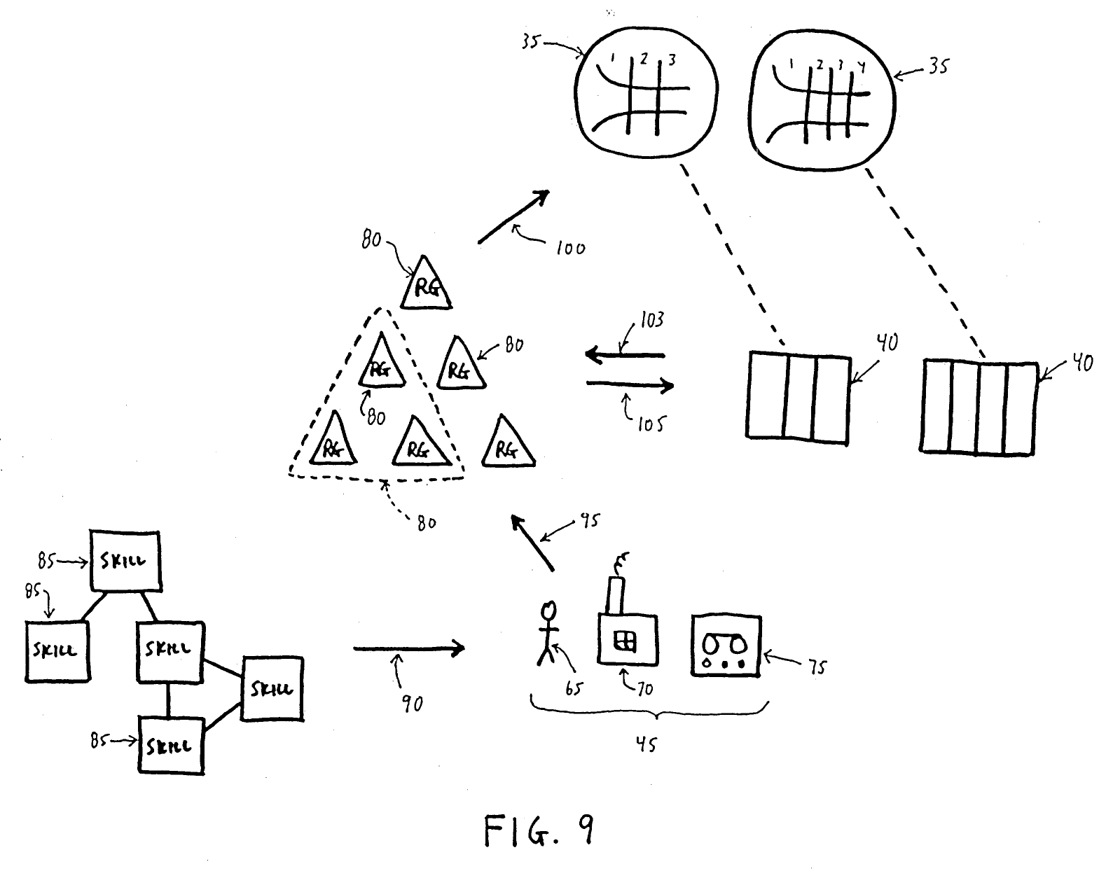

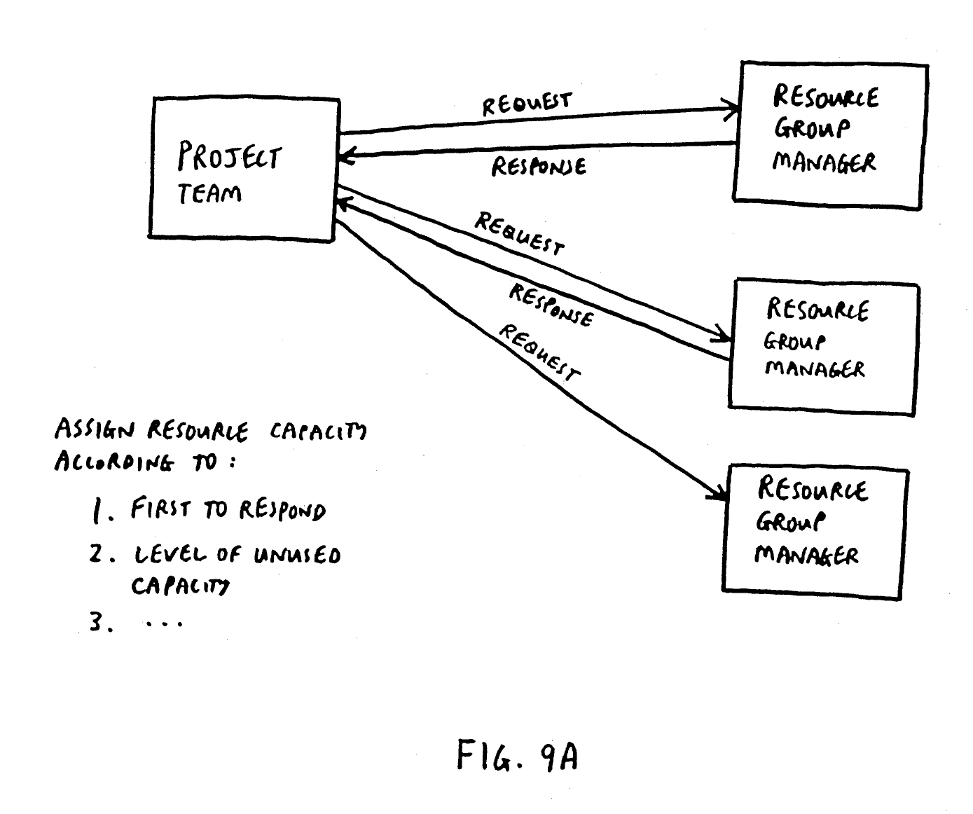

Looking next at FIG. 9, there is schematically illustrated a preferred method for resource configuration and assignment. This preferred method comprises the following steps:

1. the process planner configures the resource group hierarchy;

2. the process planner configures the skill family definitions;

3. the resource manager associates zero or more skills to a resource (see the arrow 90 in FIG. 9);

4. the resource manager associates each resource to a particular resource group (see the arrow 95 in FIG. 9)—this association is commonly to a lowest level resource group, but it could be to a higher level resource group if desired;

5. the process planner associates specific resource groups to specific portfolios, thereby establishing the “default” pool of resources which a specific project in a specific portfolio may draw on (see the arrow 100 in FIG. 9);

6. resource needs are issued as requests (see the arrow 103 in FIG. 9); and

7. resources are assigned to specific projects (see the arrow 105 in FIG. 9).

Items 1-5 above effectively amount to the configuration of the resources.

Items 6 and 7 above effectively amount to a resource assignment transaction.

With respect to Items 6 and 7 above, i.e., resource assignment, the system is configured to do this on two levels, dealing first with capacity and then with specific resources. For the purposes of the present invention, the term “capacity” is intended to mean the aggregation of resource capabilities, but not identified as to specific resource units. The assignment of resource capacity to specific projects is a dynamic process which (see FIG. 8) becomes progressively more specified over the life of the project. Furthermore, as the system becomes progressively more specified with respect to a given project, resource assignment can be done on the basis of the overall project or on a phase-specific basis or on a step-specific basis.

There are three techniques for assigning resource capacity to projects.

A first technique utilizes the following process:

1. the project team issues a list of “needs” as requests which are directed to appropriate resource groups based upon resource configuration;

2. one or more resource group managers analyze the request and make determinations as to resource assignment; and

3. the project receives the capacity decided on by the resource manager.

A second technique for assigning resource capacity to projects utilizes the following process:

1. the project team issues a list of “needs” as requests which are directed to appropriate resource groups based upon resource configuration;

2. one or more resource group managers analyze the request and make a determination as to resource capacity assignment;

3. the determination of the resource group manager is passed on to the portfolio manager, who then approves, disapproves or modifies the determination, and then sends it back to the resource manager; and

4. the project receives capacity decided on by the portfolio manager.

A third technique for assigning resource capacity with projects utilizes the following process:

1. the project manager issues a list of “needs” as requests which are directed to appropriate resource groups based upon resource configuration;

2. one or more resource group managers analyze the request and make a determination as to resource capacity assignment;

3. the project receives a tentative capacity assignment based on the determination made by the resource manager; and

4. the portfolio manager approves the determination made by the resource manager, and the assignments are confirmed.

With respect to the aforementioned three different techniques for assigning resource capacity to projects, it will be appreciated that they all share a common second step, i.e., “one or more resource group managers analyze the request and make a determination as to resource capacity assignment”. In this respect, it should be appreciated that the system is configured so that it can utilize various methods for implementing this procedure when more than one resource group manager responds to a request. For example, in one simple method, resource capacity is assigned according to which resource group manager responds first. Alternatively, where several resource group managers respond to a request, resource capacity can be assigned on a pro rata basis, according to the unused resource capacity of each responding resource group. See, for example, FIG. 9A.

Two significant advantages are achieved by using the aforementioned system of resource configuration and assignment.

First, by creating a general structure of resource configuration and then associating resource capacity into that general structure, it is possible to extract out resource capacity information at any level of aggregation within the system. In other words, it is possible to look at any level of portfolio or project, or any level of skill, or any particular resource, to determine resource utilization (including bottlenecks) within the system.

Second, by creating the general structure of resource configuration and assignment across the enterprise, it is possible to identify how projects and resources affect one another. This allows managers to see the influence of projects and resource groups on each other, both when the projects and resources are closely associated within the enterprise, and when the projects and resources are loosely associated within the enterprise.

### Process Hierarchy

As noted above, one consequence of the system's architecture is that all of the projects 40 in a given portfolio 35 must conform to the criteria specified for that portfolio by the process planning and management component 25, i.e., all of the projects 40 must track against, and report on the basis of, (1) the same structured development process 47 (e.g., phases 50), (2) the same strategic data, and (3) the same skills. In essence, with the unique architecture of the present system, the structured development process, strategic data and skills defined for a given portfolio during the process planning stage is automatically imposed upon all of the projects grouped within that portfolio.

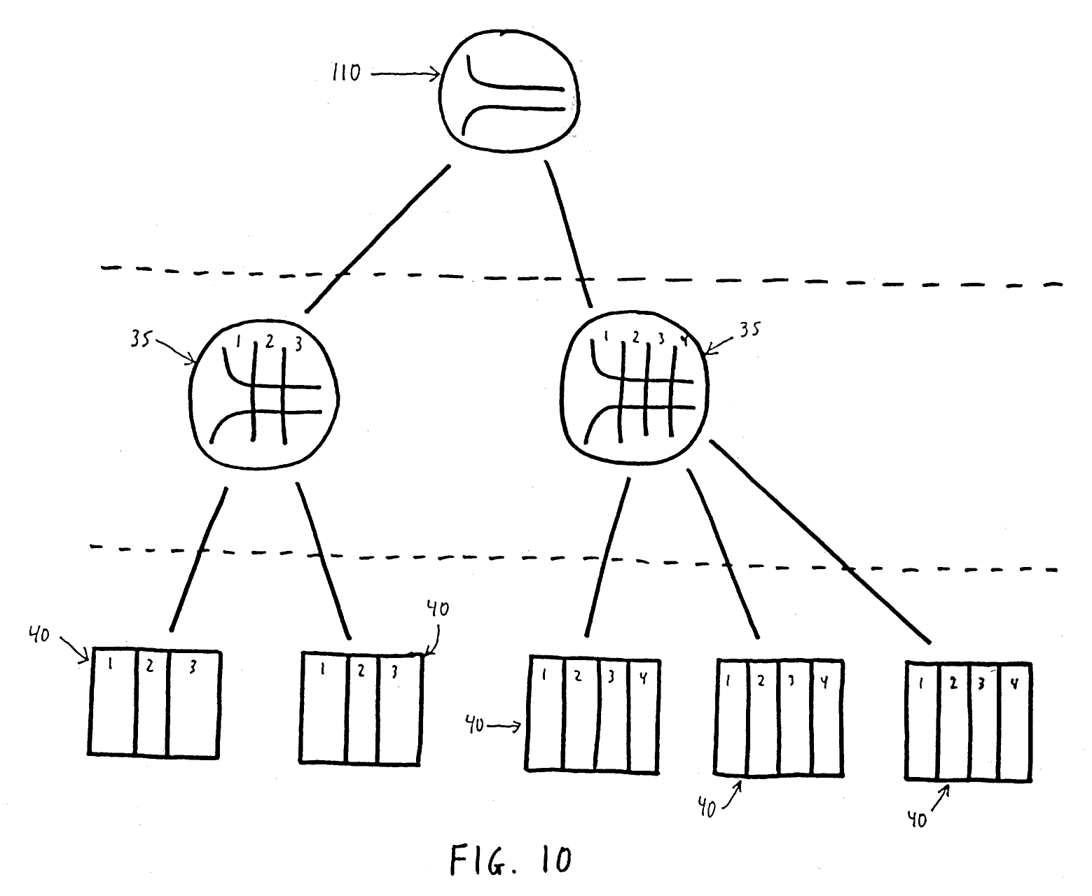

This concept is illustrated schematically in FIG. 10, where a number of different portfolios 35 are shown, each with a number of projects 40 assigned thereto. This relationship can be thought of as a process hierarchy, with each of the projects 40 residing “below” a “parent” portfolio 35 and inheriting from that parent portfolio the specific criteria which is to be tracked for each project (i.e., the structured development process, strategic data and skills).

In accordance with a further significant feature of the present invention, it has also been recognized that portfolios can have their own hierarchy, i.e., two or more portfolios 35 can themselves be associated with another portfolio, e.g., a “superportfolio” 110, wherein the portfolios 35 inherit their tracking criteria from the superportfolio 110 and then, in turn, impose that inherited criteria on all of the projects 40 below them.

In other words, as shown in FIG. 10, a consequence of the system's architecture is that there is a hierarchy, or system of inheritance, from superportfolio to portfolio to projects, etc., with each constituent in the system following the criteria imposed on it by the constituent immediately above it.

### Reconciliation Engine—Scheduling

As noted above, all of the projects within a given portfolio are required to conform to the same objective standards. Among these shared standards are the structured development process 47 (i.e., the relationship between phases, etc.) which is common to all of the projects in the portfolio.

The use of a common standard among all of the projects in the portfolio is a powerful tool, since it allows data to be accurately and reliably aggregated upward from the project level to the portfolio level.

Furthermore, due to the nature of how the system organizes its data, this aggregation can be done with a “continuous zoom”, in the sense that the level of data granularity can be adjusted in a relatively continuous fashion.

And by implementing the preferred form of the invention in software, this aggregation can be accomplished in real-time, on an enterprise-wide basis, thereby providing the enterprise management with a truly powerful and uniquely integrated planning, integration, analysis and management tool.

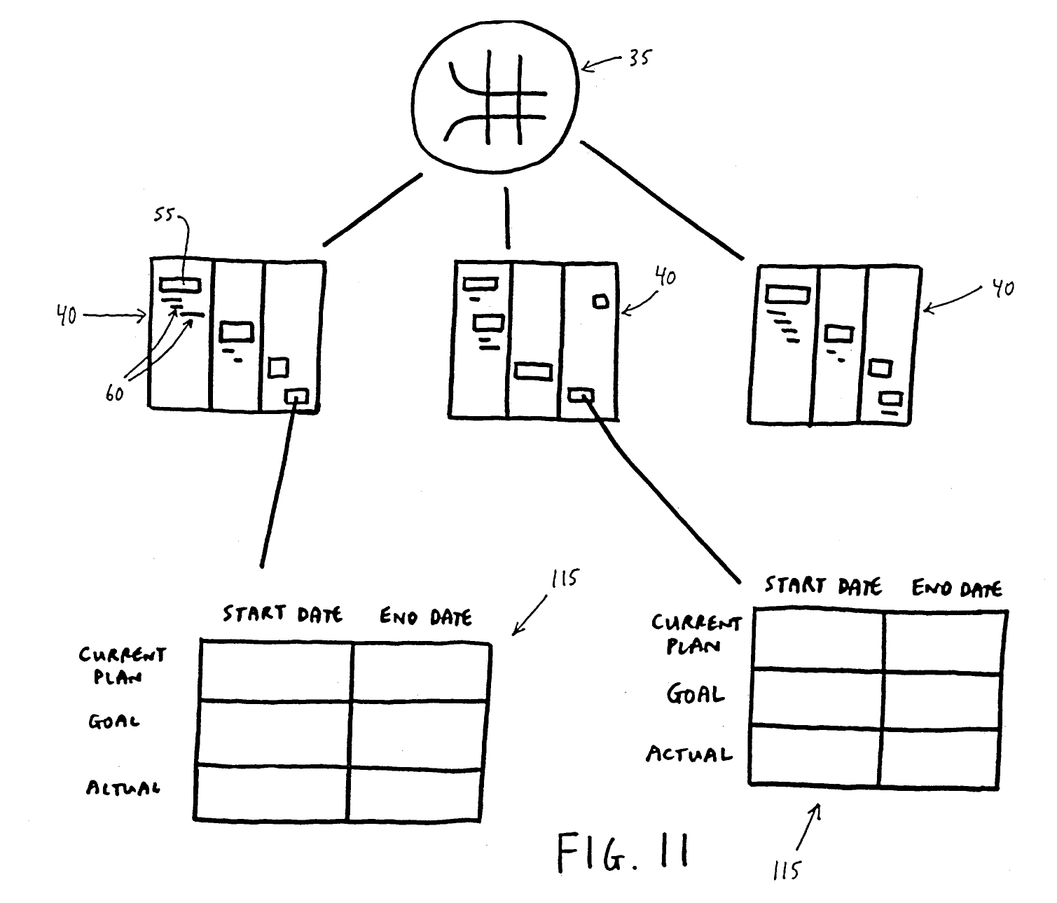

More particularly, and looking now at FIG. 11, there is shown, in schematic form, a portfolio 35 which has three projects 40 assigned thereto. The system is configured so that for each item in the structured development process 47, six pieces of data are tracked, i.e.:

1. Current Plan—Start Date

2. Current Plan—End Date

3. Goal—Start Date

4. Goal—End Date

5. Actual—Start Date

6. Actual—End Date

In one preferred form of the invention, these six pieces of data are stored in an appropriate data table 115 (FIG. 11).

Current plan information, and actual information, is adjusted on a continuous basis. Goal information is typically adjusted on a periodic basis, e.g., at the end of each phase.

By tracking these six criteria for each item in the structured development process, important benefits can be obtained. More particularly, by tracking these six criteria, the system can notify managers of “slips” in the system, i.e., where current plan, goal and actual dates vary from one another.

Of course, if the system notified every manager of every “slip” in the system, managers would be overwhelmed by the shear volume of information. Therefore, it is important that the system be able to discriminate as to which managers are to be notified as to which “slips”. With the present invention, this is made possible due to the way in which the system organizes its information. In particular, due to the system's reconciliation engine, it is possible to establish a “sliding scale” of alerts which discriminates between which managers are alerted to which “slips”.

With the present invention, system alerts can be generated on the basis of two different criteria: either implicitly or explicitly. An implicit alert is generated according to a set of pre-established rules which take into account the level of the manager and the type of slip involved. An explicit alert is generated according to a manager's specific request to be alerted to a specific slip.

More particularly, an implicit alert is generated according to pre-established rules, i.e., the system can be configured so that a portfolio manager is alerted when a project phase is missed but not when a task is missed, whereas a project manager is alerted when a task is missed, as well as when a project phase is missed, etc.

In this respect it should also be appreciated that the system can be configured so that a “slip” is defined in relative terms, i.e., the system can be configured to permit a level of tolerance to be assigned to a date. In other words, the system can be configured to give a “grace period” around a deadline.

Furthermore, the system is also configured so that alerts can be proactive as well as reactive. In other words, by looking at “current plan” dates versus “goal” dates, the system can provide alerts as to anticipated slips.

As noted above, an explicit alert is generated according to a specific request by a manager, e.g., manager X has a significant interest in a specific high level task, and instructs the system to issue an alert with respect to any slips affecting that task.

### Reconciliation Engine—Resources

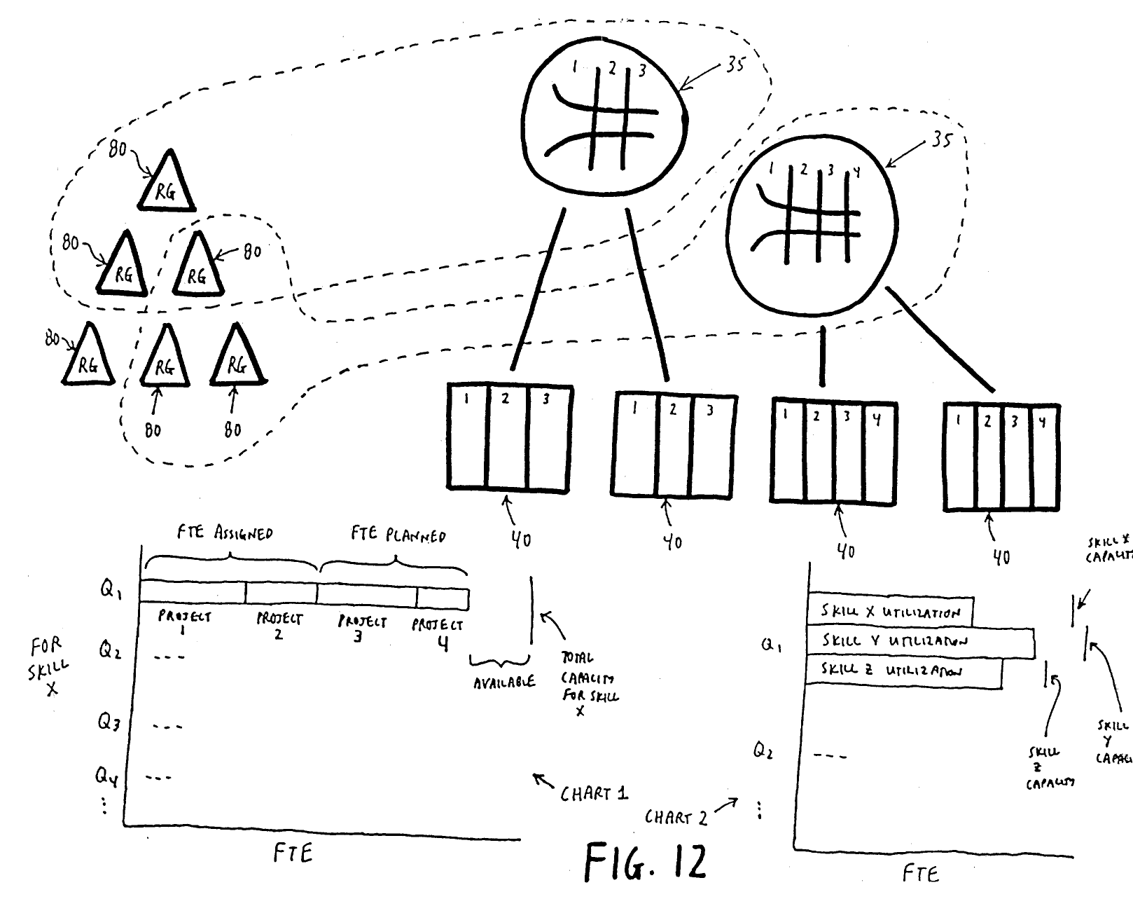

As noted above, and looking now at FIG. 12, all of the projects 40 belong to some portfolio 35, with clearly defined constructs relating the projects to the portfolios. At the same time, specific resource groups 80 are associated with specific portfolios 35, with specific resources assigned to specific projects. Thus, there is a unifying construct between portfolios, projects, resource groups and resources. The use of this unifying construct is a powerful tool, since it allows resource data to be accurately and reliably aggregated both vertically and horizontally within the system. Furthermore, due to the nature of how the system organizes its data, this aggregation can be done with a “continuous zoom”, in the sense that the level of data granulation can be adjusted in a relatively continuous fashion. In addition, this aggregation can be based on existing and/or proposed projects, and existing and/or proposed resource capacity, thereby permitting the user to conduct “what if” analyses. And by implementing the preferred form of the invention in software, this aggregation can be done in real-time, on an enterprise-wide basis. Central to one aspect of this invention's novelty lies the fact that it is not resource capacity in a vacuum—the capacity the system calculates from is added to, and reduced from, in a dynamic, real-time seamless manner. The capacity of resources is integrated with the needs of projects which are integrated with the portfolio strategy.

Thus, for example, and looking now at Chart 1 in FIG. 12, with the present invention it is possible to generate a chart, for any given skill, which will show, for a particular time period, the total FTE assigned and/or planned, broken out on a project by project basis. This can be an important measure, since it can be compared with the total capacity for that particular skill, whereby to identify imbalances between the supply and demand of the specified skill. The ability to access capacity utilization trends over time is an important feature of not only this chart in particular but also the system in general, for once those trends are determined, portfolio managers can then align the currently-utilized and planned capacity with the dynamic strategy of the portfolio.

Additionally, and looking now at Chart 2 in FIG. 1, it is also possible to use the information available in the system to generate a chart showing, for any particular time period, the difference between the capacity for each skill and the level of utilization for that same skill.

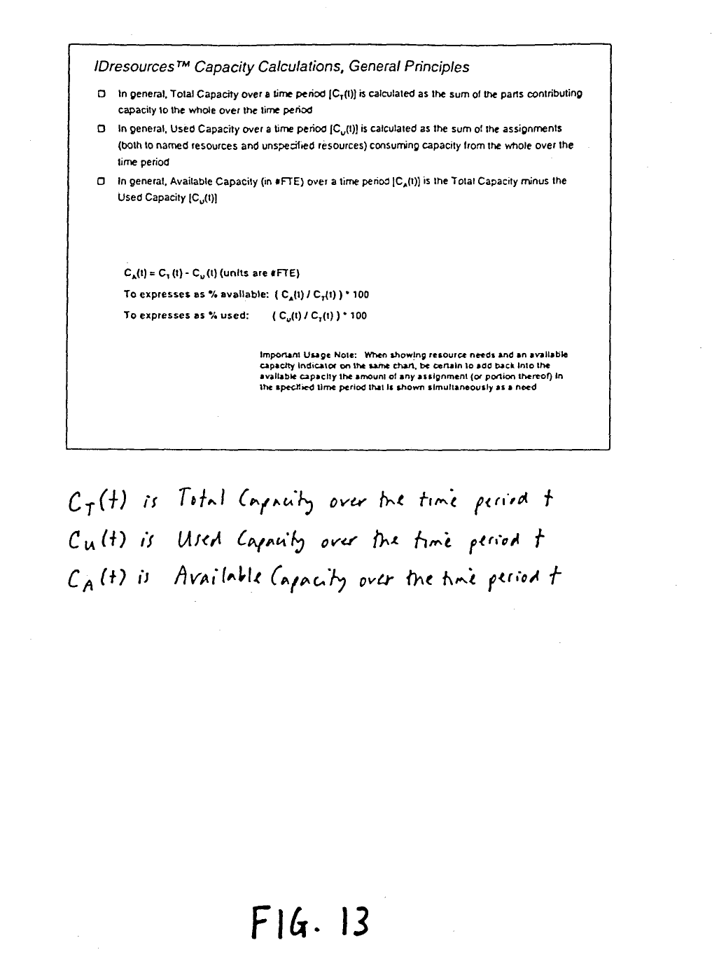

Looking next at FIG. 13, there is shown a general methodology for calculating capacity in various situations in the system.

### First Addendum

Still other objects and features of the present invention are disclosed in a first collection of pages entitled “Integrated Development Enterprise, Inc. IDresources™”, a copy of which is attached as APPENDIX H, and a second collection of pages marked “ADDITIONAL SHEETS”, a copy of which is attached as APPENDIX I.

### System Security

In the preceding discussion, there was disclosed a novel structured system for the planning, integration, analysis and management of new product development on a real-time, enterprise-wide basis. In this discussion, the system was discussed in the context of a single, “open” enterprise, with considerations of security being omitted from the discussion. Indeed, in the foregoing discussion, it was noted that a primary object of the present system is to provide the opportunity for users at every level to have as much access as possible to the information contained in the system. Thus, for example, the system is capable of compounding data upwards so that the aggregated data can be used at the highest levels for strategic planning purposes; at the same time, however, the system is also configured so as to maintain its data at varying levels of “granularity” so that the data can be used at lower levels for more specific purposes.

Of course, in most real-world situations, it is generally necessary to restrict access to the system to at least some extent. Thus, for example, users within the enterprise might be given access to information within the system, whereas those outside the enterprise might be prohibited from accessing information within the system. Furthermore, a high level user within the enterprise might be given access to all of the information within a range of portfolios, whereas a lower level user might only be given access to the information within a particular project, i.e., a project with which that lower level user is involved. In addition, to the extent that a user is given access to information within the system, the nature of that access might differ according to the status of the user. For example, a higher level user might be given the authority to both view and modify data within the system, whereas a lower level employee might only be permitted to view data within the system.

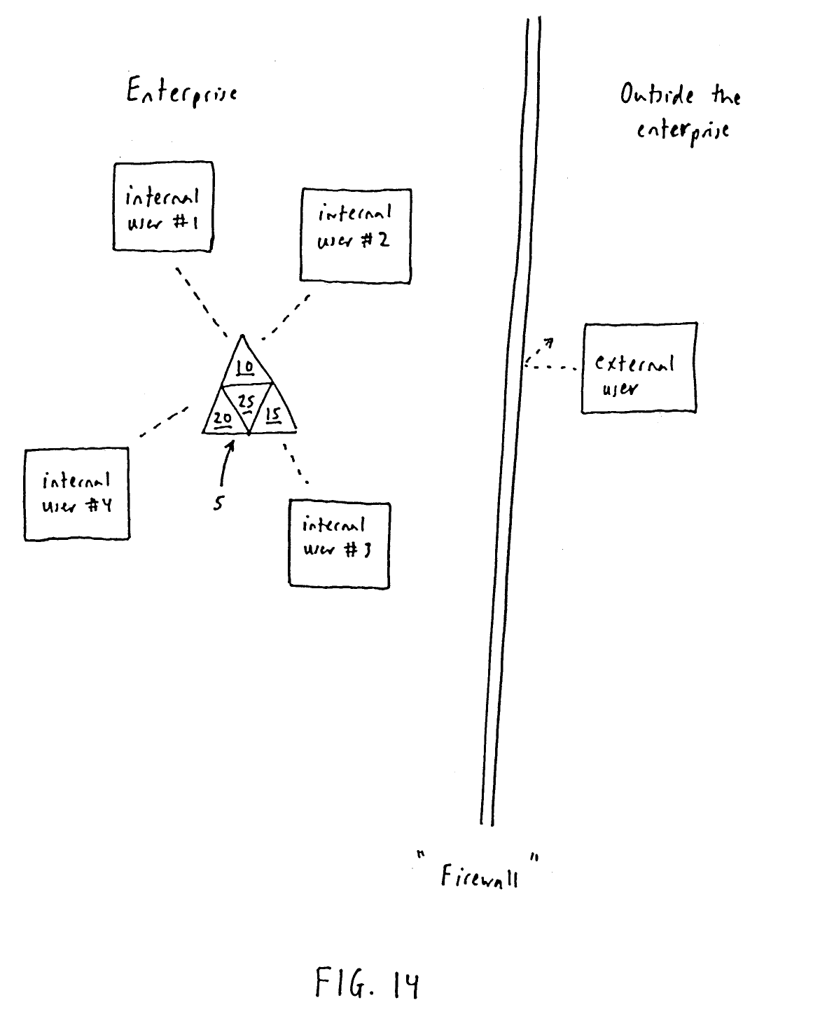

Thus, in one preferred embodiment of the system, the system is configured so that only users within the enterprise have any access to the information contained within the system. This is done by creating a so-called “firewall” (see FIG. 14) to prohibit those outside the enterprise from accessing information within the system.

In this preferred embodiment of the system, the system is further configured so that each user may have their access authorized on (1) a project-by-project basis, and (2) a “view only” or “view and modify” basis. More particularly, in this particular preferred embodiment of the system, the system is configured so that a specific user may be authorized for access to one or more specific projects and, for each such authorized project, the user will then be authorized to either view, or view and modify, the data for that project.

Furthermore, in this particular preferred embodiment of the system, the system is further configured so that the user's level of authorization for a project applies identically across all of the data for that project, i.e., if the user is authorized to view data for a project, the user is authorized to view all of the data for that project, or if the user is authorized to view and modify the data for a project, the user is authorized to view and modify all of the data for that project.

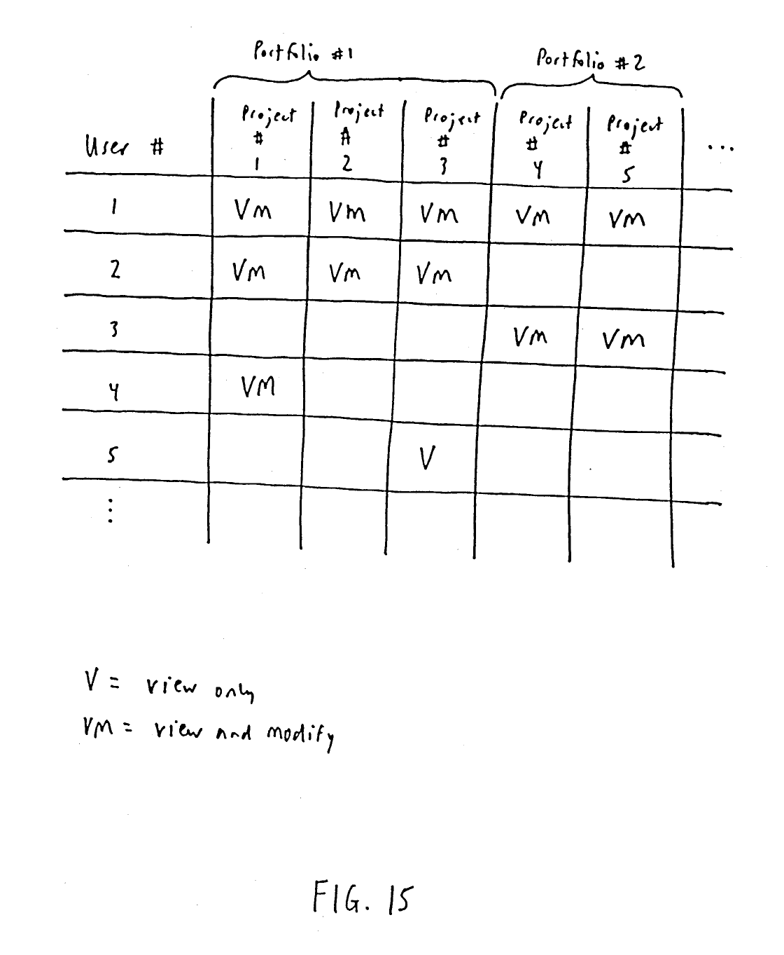

Thus, for example, in FIG. 15 there is shown an authorization table which might be created in accordance with the aforementioned embodiment of the system. In this example, Projects 1-3 might be grouped in Portfolio 1, Projects 4 and 5 might be grouped in Portfolio 2, etc. In this example, if User 1 was the Director of Research and Development for the entire enterprise, User 1 might be authorized to view and modify the data in Projects 1-5; if User 2 was the Portfolio Manager for Portfolio 1, User 2 might be authorized to view and modify the data in Projects 1-3 (i.e., the projects in Portfolio 1); if User 3 was the Portfolio Manager for Portfolio 2, User 3 might be authorized to view and modify the data in Projects 4-5 (i.e., the projects in Portfolio 2); if User 4 was the Project Manager for Project 1, User 4 might be authorized to view and modify the data in Project 1; if User 5 was a low-level intern in the marketing department and working on marketing for the product being developed in Project 3, User 5 might be authorized to view data in Project 3, etc.

### External Partners

In the particular system embodiment described above, system security is effected by a two-part process: first, access is restricted to only internal users (i.e., to only those who are within the enterprise) and second, access for these internal users is further restricted on a project-by-project basis, according to a “view only” or “view and modify” authorization.

This manner of effecting system security adequately addresses the needs of many real-world enterprises, and can be preferable since it is relatively easy to implement, administer and maintain.

However, in some circumstances, the enterprise may pursue its product development processes with the assistance of external partners. In these circumstances, it can be highly advantageous for the external partners to have some degree of access to the system, so that the efforts of the external partners can be closely coordinated with the efforts of the enterprise. In this case the external partners might be permitted to access information about certain projects in the system. Furthermore, in this respect, the external partners might be authorized to both view and modify data within the system, or they might only be permitted to view data within the system.

For example, suppose the system is being used by an automotive company to design a new car. In this circumstance, the company might develop every component of the new car internally, i.e., within the company. However, a more realistic scenario is for the company to establish relationships with various subcontractors (i.e., external partners) for the production of selected components, e.g., the transmission. In this situation, it is generally desirable for there to be a high degree of coordination between the company (i.e., the enterprise) and its subcontractor (i.e., the external partner). Thus, the enterprise may wish to permit the external partner limited access to the system.

There are several preferred ways that the enterprise can permit the external partner limited access to the system.

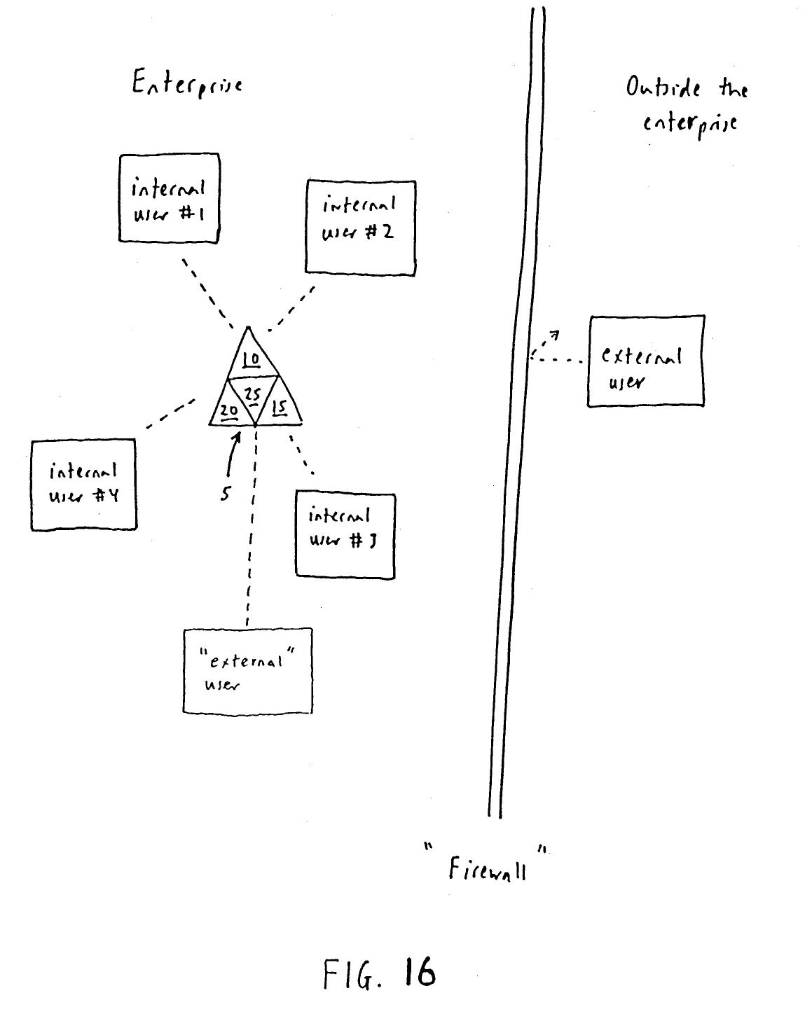

In a first preferred implementation, and looking now at FIG. 16, an external user may be given access to the system by simply treating the external user the same as an internal user, i.e., by locating the external user within the firewall. In this implementation, the external user is given access authorization in substantially the same manner as an internal user, e.g., such as by the authorization table shown in FIG. 15.

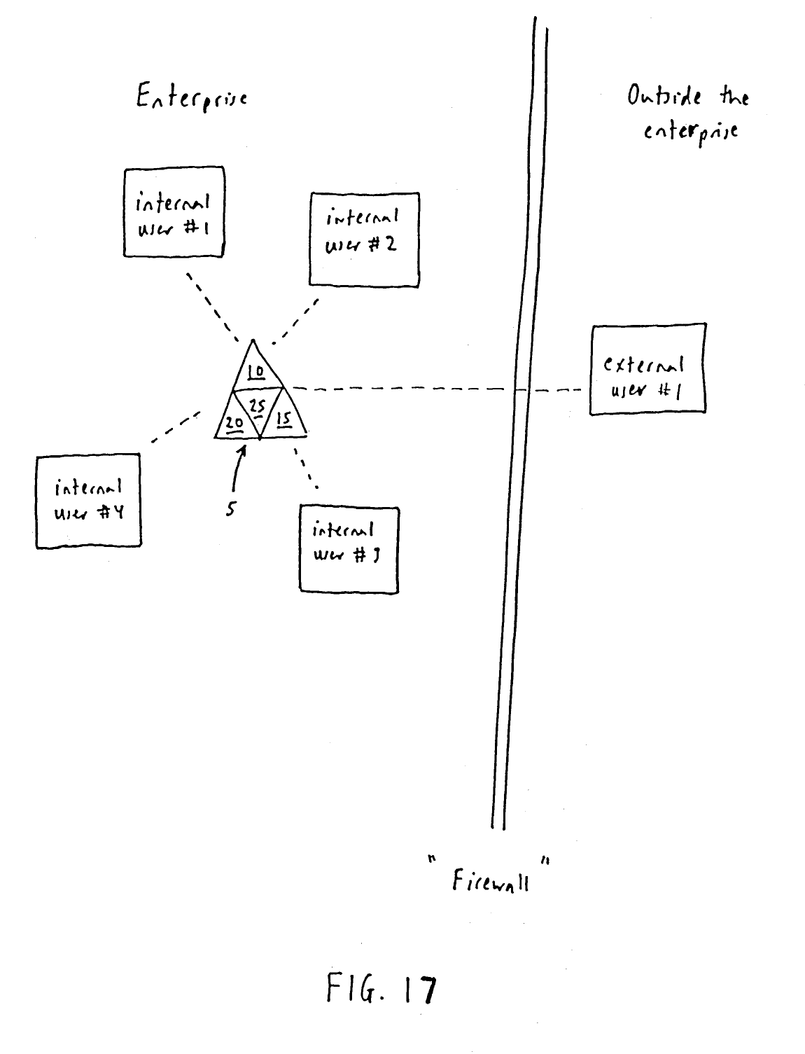

In a second preferred implementation, and looking now at FIG. 17, an external user is located outside the firewall. In this implementation, the external user is given the information necessary to traverse the firewall, and then the external user is given access authorization in substantially the same manner as an internal user, e.g., such as by the authorization table shown in FIG. 15. Thus, with this preferred implementation of the system, the external user must first successfully traverse the firewall in order to gain access the system and, even then, access to the system will be restricted to the extent permitted by the authorization table.

In many situations, the two foregoing implementations can be quite satisfactory, since they provide an external partner with limited access to the system. However, in either case, this access is based upon a project-by-project authorization; and where access to a particular project is authorized, such access extends across the entire project, limited only by the user's “view only” or “view and modify” authority. In many circumstances it may be desirable to provide greater discrimination on the nature of the external partner's access.

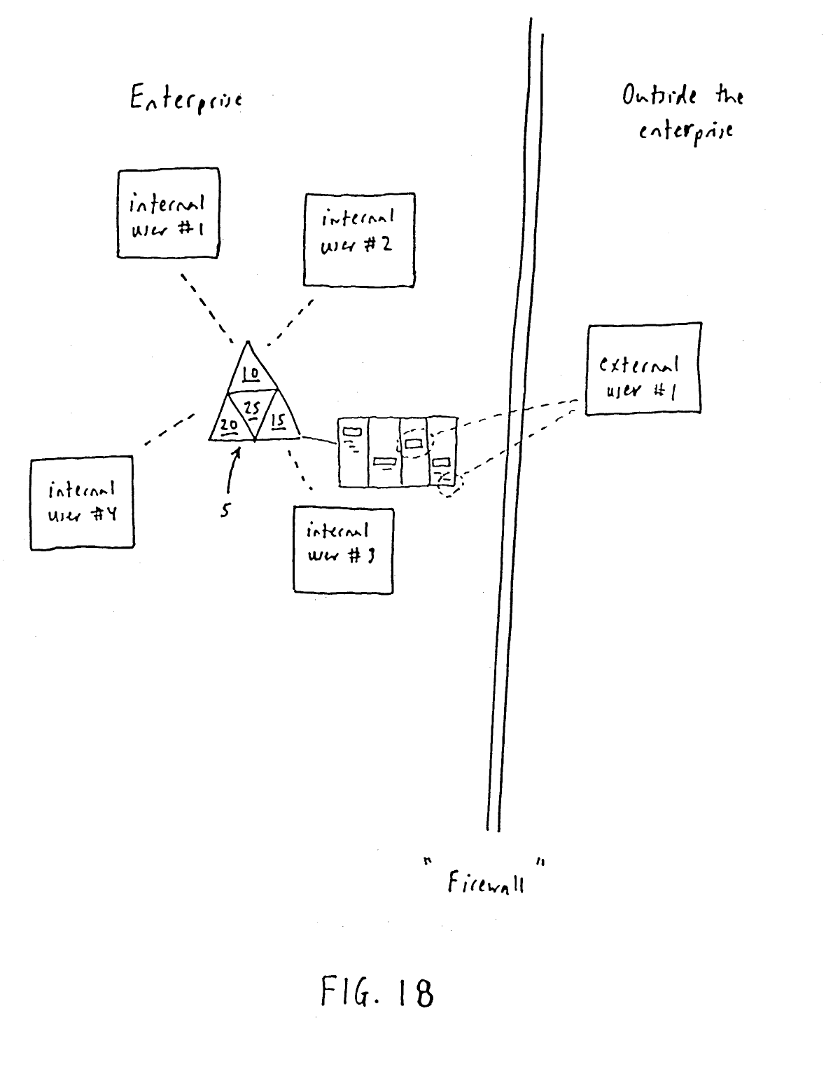

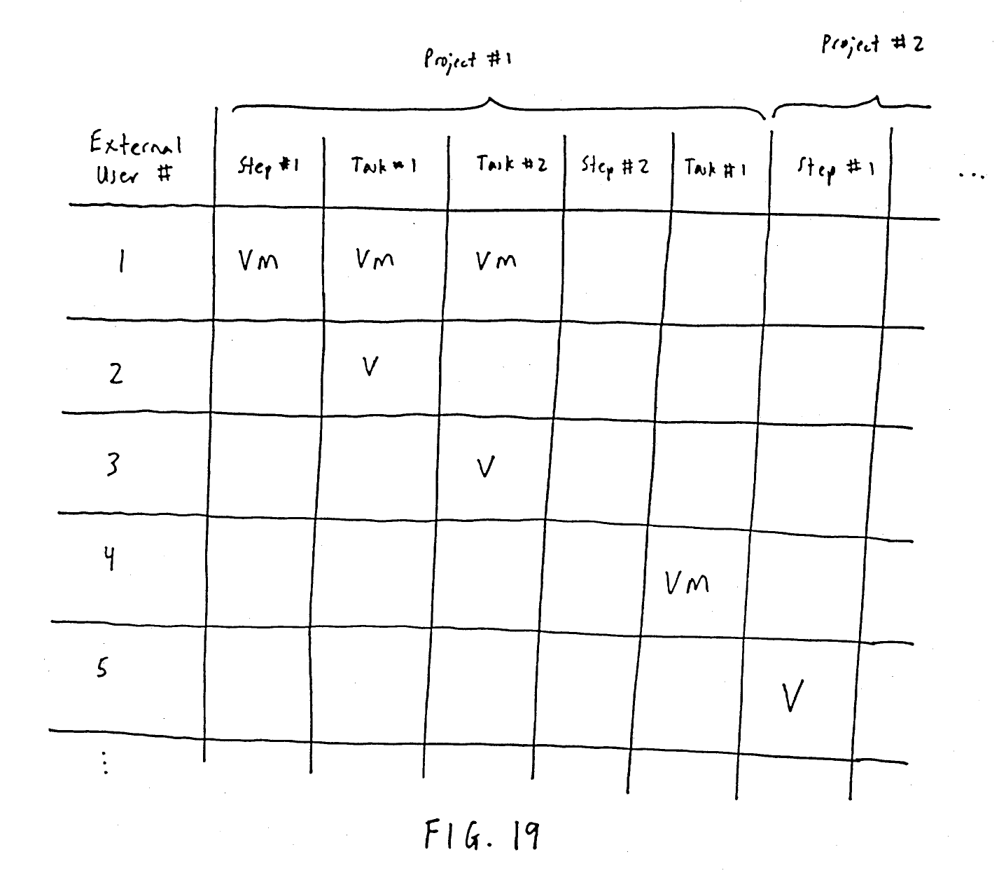

Thus, in a third preferred implementation, and looking now at FIG. 18, an external partner may be authorized for access to the system on an individual step or task basis, rather than on a project-wide basis as discussed above. In this respect, and returning now to FIG. 3, it will be recalled that all projects 40 include one or more phases 50; and each phase 50 may include one or more steps 55; and each step 55 may include one or more tasks 60, etc. In this third preferred implementation of the system, and looking now at FIG. 19, each external user may be authorized for access to the system on the basis of individual steps or tasks.

In the preceding paragraph, it was disclosed that an external partner may be authorized for access to the system on an individual step or task basis, rather than on a project-wide basis as discussed above. In this respect it should be appreciated that the system may also be configured so that an “internal” user may be authorized for access on the same basis, e.g., on an individual step or task basis.

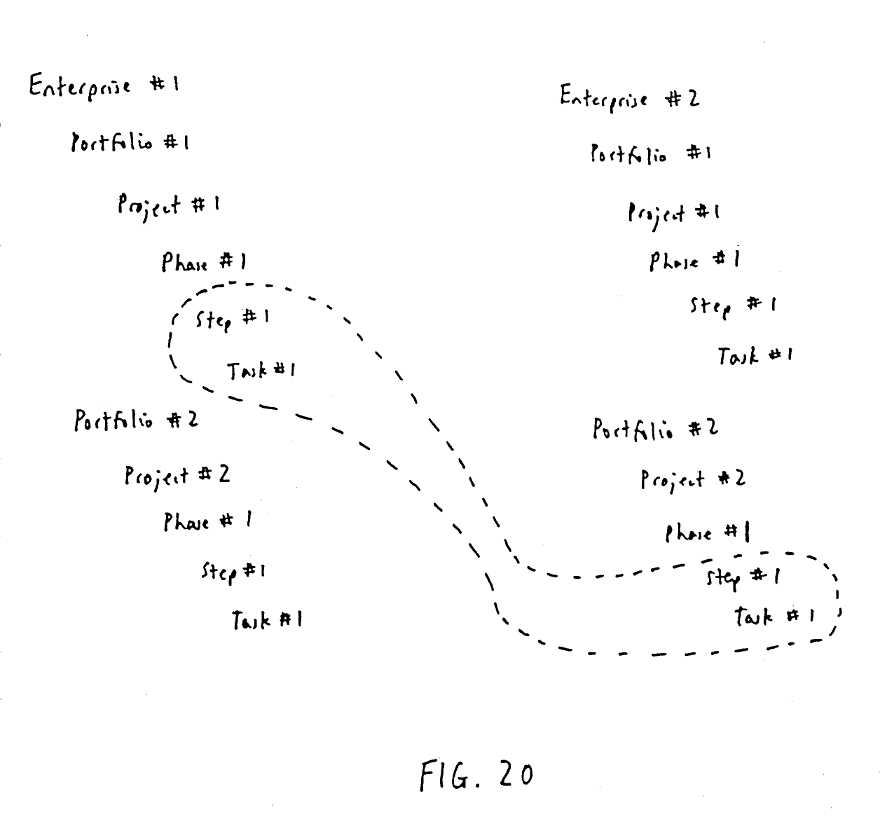

It should also be appreciated that where two separate enterprises are participating in a joint project, and each is using the system of the present invention, the two enterprises may share common elements of a structured development process 47. See, for example, FIG. 20.

### Second Addendum

In one preferred implementation of the present invention, selected system security and external partners features are embodied in software developed by Integrated Development Enterprise of Concord, Massachusetts under the name IDpartner.

Further details regarding selected system security and external partners features are disclosed in the product brochure for IDpartner™ (entitled “Idpartner EXTENDING THE DEVELOPMENT CHAIN”), a copy of which is attached as APPENDIX J, and in a collection of pages entitled “ADDITIONAL SHEETS II”, a copy of which is attached as APPENDIX K.

### Product Data Objects (PDO'S)

In many circumstances, it may be desirable to track information simultaneously across projects and across various organizational entities.

In accordance with the present invention, Product Data Objects (PDO'S) have been created to provide this facility.

PDO's are essentially objects that collect and store financial or other numeric data relating to projects and/or organizational entities.

All PDO'S are created through a three step process. First, the PDO is defined. Second, the PDO is assigned, i.e., it is linked to the source(s) of the data that will be tracked by the PDO. Third, the PDO is populated with data.

Defining a PDO

A PDO is defined by identifying seven basic metadata items, or fields, which will be tracked for that PDO. These metadata items are as follows:

(1) Name;

(2) Description;

(3) Time Interval;

(4) Number Of Periods;

(5) Currency Or Not (check box);

(6) Units; and

(7) a Display Order.

The Name field is simply that—a unique name by which the PDO will be identified to users of the system.

The Description field is a brief description of the subject matter of the PDO, e.g., the purpose or use of the PDO. The Description field may also be used to provide other useful information (e.g., instructions or notes) to users of the system.

The Time Interval field identifies the time period (i.e., days, weeks, months, quarters or years) for measuring the data which the PDO will track.

The Number Of Periods field identifies the initial number of periods for which the PDO will track data.

The Currency Or Not (check box) field identifies the nature of the data being tracked by the PDO, i.e., either currency or numeric. Where the Currency Or Not check box is checked by the user, i.e., to denote that the data relates to currency, the system can then automatically prompt the user (e.g., through the use of a drop-down menu) to identify the currency involved, e.g., U.S. dollars, British pounds, Euros, etc.

The Units field identifies the units in which the PDO will be expressed, e.g., ones, thousands, millions, etc. This feature can be particularly useful in accounting systems, where numbers are frequently reported in terms of thousands (e.g., '000s) or millions (e.g., mils).

The Display Order field identifies the order in which the PDO's will be listed to users of the system when displaying PDO assignments (see below) and provides, through the use of “Move Up” and “Move Down” buttons, the opportunity to adjust the order in which that PDO will be displayed relative to other PDO's in the system when providing a display of PDO assignments.

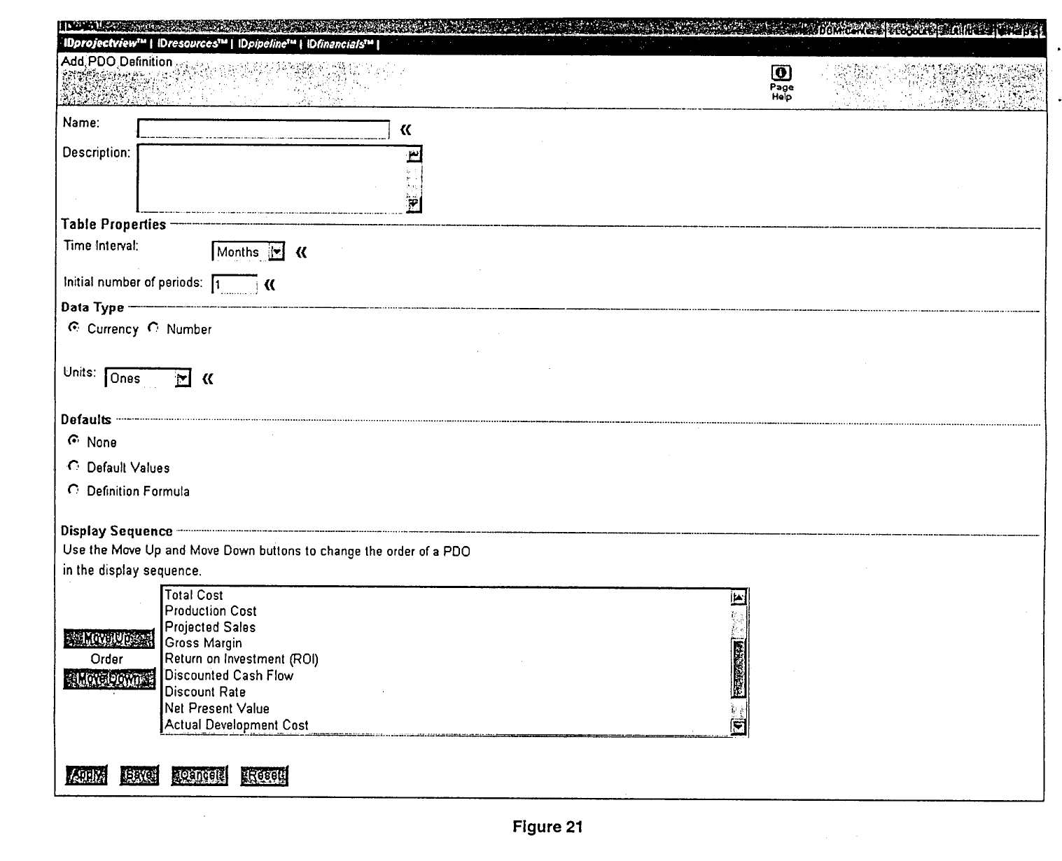

A PDO is defined by using an Add PDO Definition Screen, such as that shown in FIG. 21.

After a PDO has been defined, it essentially comprises an empty shell, in the sense that the PDO has not yet been linked to other system elements (e.g., to projects and/or to organizational entities), and in the sense that the PDO has not yet been populated with data.

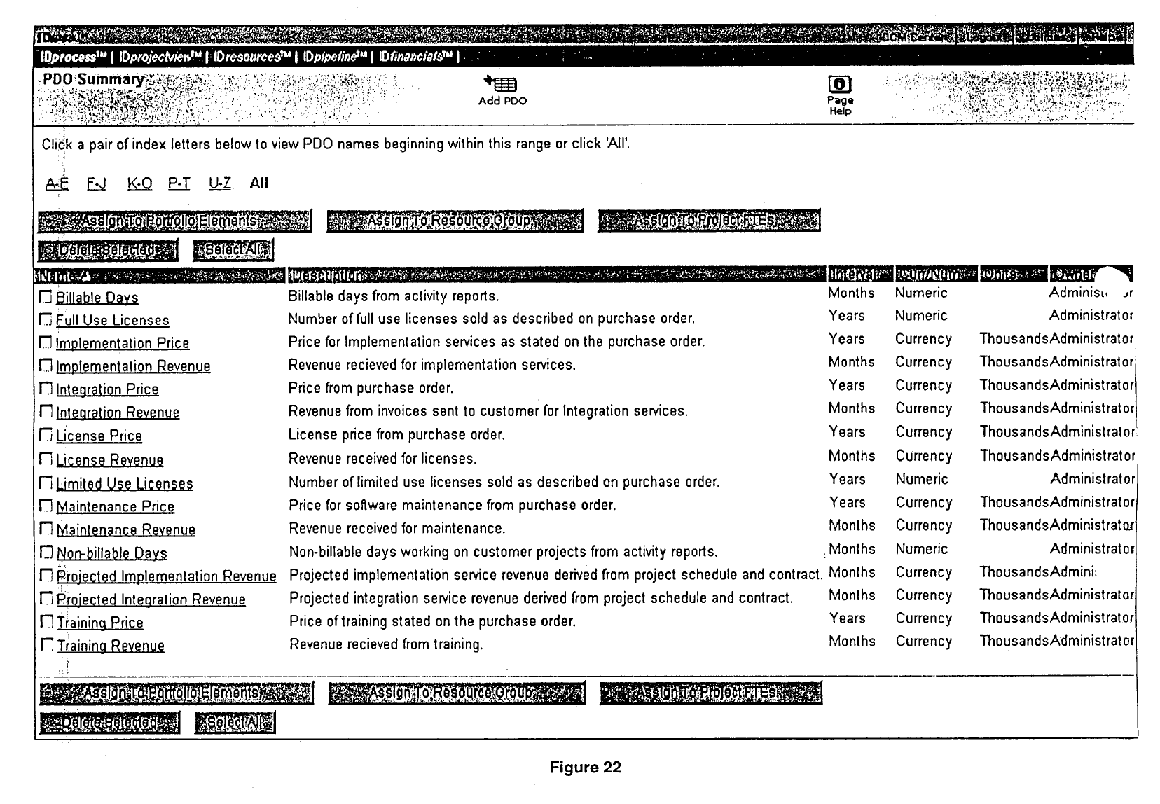

After a PDO has been defined, it can be displayed, along with the other defined PDO's, using a PDO Summary Screen, such as that shown in FIG. 22.

Assigning a PDO

Assigning a PDO is the mechanism by which the PDO is linked to the source(s) of data that will be tracked by the PDO. The process of assignment is essentially the creation of the pipeline to the source(s) of data that will populate the PDO. Significantly, the source(s) of this data will generally be other system elements and, perhaps even more significantly, will typically constitute data which is already being tracked for other system elements, e.g., data being tracked for projects which are already in the system. As a result, by assigning the PDO to other system elements, a powerful data mining tool can be created without necessarily requiring the collection of new data.

It should be appreciated that a PDO “assignment”, as the term is used in this section, is not the same as a resource “assignment”, as that term has been used in previous sections. A PDO assignment relates to linking a PDO with its source(s) of data; a resource assignment relates to the assigning of productive assets (e.g., people, plants, machines, etc.) to a project.

A PDO may be assigned to five different types of system elements, i.e.:

(1) a project (or project element, such as a phase, step or task);

(2) a portfolio;

(3) a cross portfolio;

(4) an entity; and

(5) a resource group.

Furthermore, while a PDO may be assigned to more than one type of system element, a given system element may only have one PDO assignment for a given PDO.

Here, the terms project, portfolio and resource group are meant to designate the same type of system elements discussed previously.

The term cross portfolio is meant to designate any selected project or projects located anywhere in the enterprise, without regard to the particular portfolio or portfolios that the project or projects may lie in.

The term entity is meant to designate an identifier for levels within a business organization. For example, the term entity may designate a business unit such as a sales organization, a marketing group, a research and development unit, etc. In essence, an entity can be virtually any organizational grouping existing within a business organization.

In this respect it should be appreciated that the ability to assign a PDO to an entity, which can be virtually any organizational grouping within a business organization, is an enormous tool, since it permits data to be reported on the basis of that entity. Thus, PDO's permit data to be mined on virtually any basis within a business organization. This is a unique and powerful feature.

Four different types of PDO assignments can be made:

(1) manual;

(2) calculated;

(3) full time equivalent (FTE); and

(4) cost FTE.

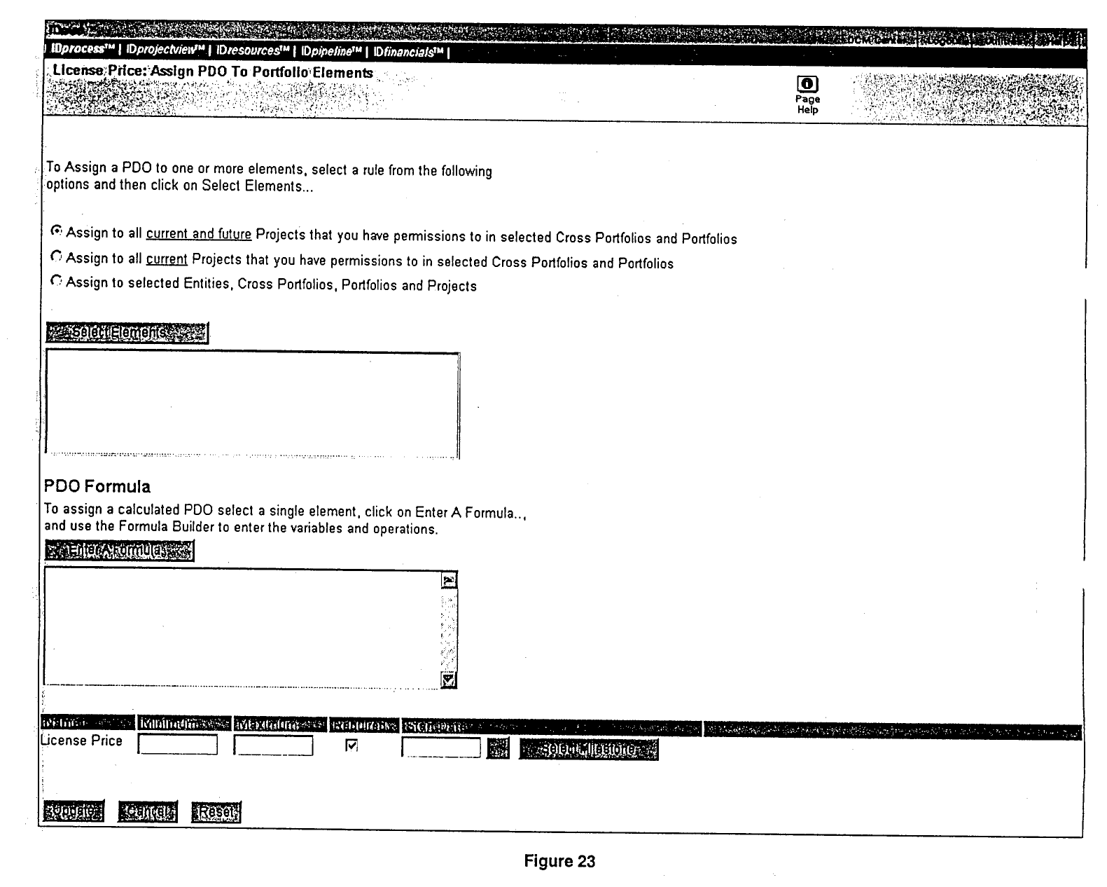

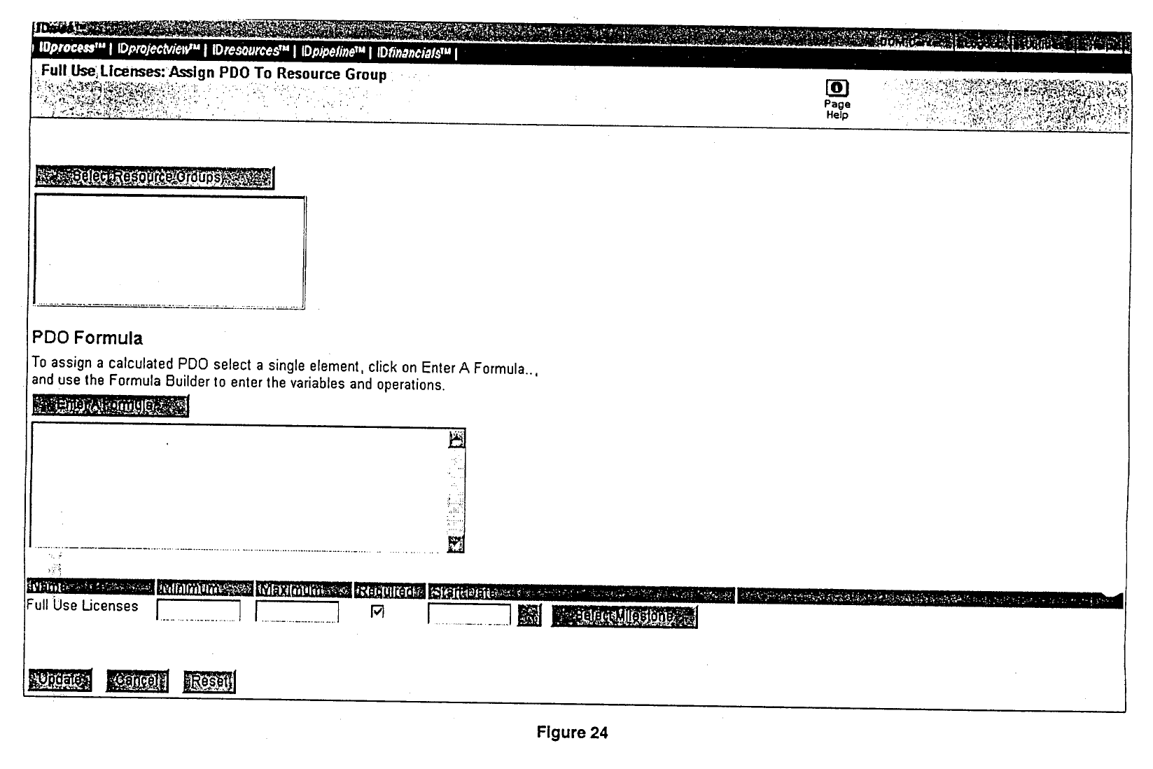

Manual and calculated assignments may be created, for example, by clicking on the “Assign To Portfolio Elements . . . ” button on the PDO Summary Screen shown in FIG. 22, which will bring up the Assign PDO To Portfolio Elements Screen shown in FIG. 23, or by clicking on the “Assign To Resource Group . . . ” button on the PDO Summary Screen shown in FIG. 22, which will bring up the Assign PDO To Resource Groups Screen shown in FIG. 24.

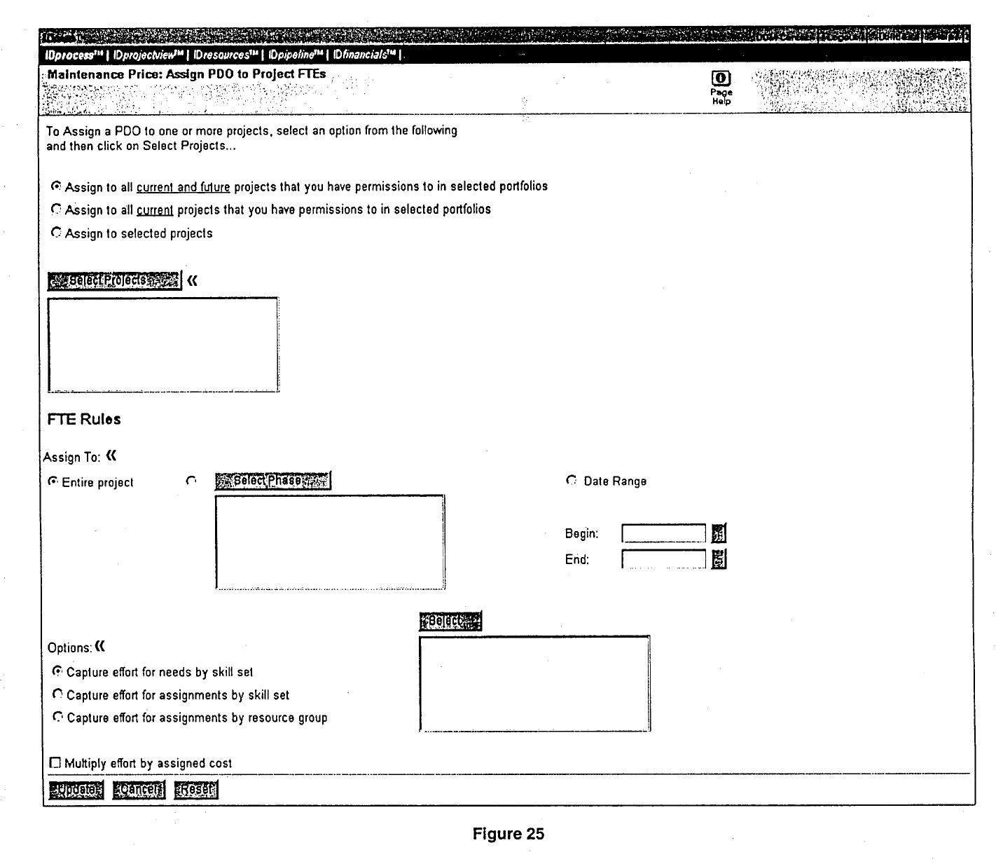

Full time equivalent (FTE) and cost FTE assignments may be created, for example, by clicking on the “Assign To Project FTE's . . . ” button on the PDO Summary Screen shown in FIG. 22, which will bring up the Assign PDO To Project FTE's Screen shown in FIG. 25.

Manual PDO Assignments

With a manual PDO assignment, the PDO is assigned to a system element, and then the “owner” of that system element (e.g., a project manager, in the case where the system element is a project) is responsible for ensuring that the proper data is entered into the system (which data will ultimately pass through to that PDO assignment).

Calculated PDO Assignments

A calculated PDO assignment is used to aggregate data from other, existing PDO assignments using a formula. For example, suppose PDO assignment #1 is a manual PDO assignment tracking a certain type of data for Project #1, and suppose PDO assignment #2 is a manual PDO assignment tracking that same sort of data for Project #2, and suppose that Project #1 and Project #2 constitute all of the projects in Portfolio A. If it is desired to track that same type of data for the entire Portfolio A, a new calculated PDO assignment, i.e., PDO assignment #3, can be established, where that PDO assignment has a formula which will automatically sum the data in PDO assignment #1 and PDO assignment #2.

FTE PDO Assignments

FTE PDO assignments permit the level of resource effort to be captured for projects.

More particularly, resource effort comprises resource needs (i.e., planned effort) or resource assignments (i.e., actual effort).

Again, it should be appreciated that a PDO “assignment” is not the same as a resource “assignment”. A PDO assignment relates to linking a PDO with its source(s) of data; a resource assignment relates to the assigning of productive assets to a project. When the term “assignment” is used in conjunction with resource effort (i.e., to denote actual effort), the term is used in the sense of a resource assignment and not a PDO assignment.

Of the five different types of system elements to which a PDO may be assigned (i.e., project or project element, portfolio, cross portfolio, entity and resource group), only projects have resource effort associated with them. Portfolios and cross portfolios are simply a summary of projects, and hence do not track resource effort (i.e., resource needs or resource assignments) directly. The same is true for entities. A resource group also does not track resource effort (i.e., resource needs or resource assignments) per se, although it does contain resources which are themselves assigned to projects.

As noted above, resource effort can be captured on the basis of resource needs (i.e., planned effort) or resource assignments (i.e., actual effort).

Resource effort is tracked on the basis of full time equivalent (FTE) units, or simply FTE's.

FTE's depend on the nature of the resources themselves: they can represent people, plants, machines, etc. One FTE represents the “full” utilization of a given unit (e.g., a person, a plant, a machine, etc.) for a given time period (e.g., an 8 hour shift, a 24 hour day, etc.).

Significantly, FTE PDO assignments can be generated out of information which is already being tracked for projects (or project elements). Thus, through the use of FTE PDO assignments, resource effort (i.e., resource needs or resource assignments) can be extracted from the data already being gathered in connection with projects. Furthermore, because FTE PDO assignments can be carefully tailored to selectively capture specific resource effort, FTE PDO assignments constitute a powerful data mining tool without necessarily requiring the collection of new data.

As noted previously, the process of assigning a PDO is essentially the creation of the pipeline that feeds data into the PDO.

When capturing data for an FTE PDO assignment, the information can be designated (i.e., filtered) on the basis of various criteria. More particularly, the data being captured for an FTE PDO assignment is captured on a project (or project element) basis, and can be further filtered on the basis of:

(1) time range (for both resource needs and resource assignments);

(2) skill set (for both resource needs and resource assignments); and

(3) resource groups (for resource assignments only).

Cost FTE PDO Assignments

As noted above, FTE PDO assignments capture resource effort (i.e., resource needs or resource assignments).

Cost FTE PDO assignments capture the cost associated with an FTE PDO assignment (i.e., the cost associated with either resource needs or resource assignments).

A Cost FTE PDO assignment is built on top of an FTE PDO assignment, i.e.:

Cost FTE PDO Assignment=FTE PDO Assignment×cost

Cost can be established by users in several ways. More particularly, when looking at planned effort, companies frequently calculate cost on a fairly generalized basis, i.e., on a portfolio wide basis or a company wide basis. However, when looking at actual effort, cost numbers are generally more easily identifiable, so cost is frequently assigned on the basis of a specific resource group or a specific resource.

Multiple Assignments

Significantly, a single PDO can have multiple assignments. Each assignment is essentially a specific instance of that PDO. Each instance typically has a different value.

By way of example, a PDO might be created to track postage. One PDO assignment might be to Project #1; another PDO assignment might be to Portfolio #15; and another PDO assignment might be to Entity #201 (representing, perhaps, a sales office in Cleveland). Each of these PDO assignments represents a different instance of the same PDO, and each PDO assignment typically has a different value. Furthermore, it should be appreciated that the various PDO assignments for a given PDO may be of different types, e.g., one PDO assignment might be a manual PDO assignment, another PDO assignment might be a calculated PDO assignment, a third PDO assignment might be an FTE PDO assignment, etc.

By way of further example, a PDO might be created to track resource effort (e.g., resource needs) for personnel. One PDO assignment might be to Project #7, and it might be a manual PDO assignment (signifying the manual entry of the data representing the resource effort being tracked); another PDO assignment might be to Project #41, and it might be an FTE PDO assignment configured to capture resource effort over a time range B and for a skill set C (representing, perhaps, C++ programmers); and another PDO assignment might be to Project #98, and it might be an FTE PDO assignment configured to capture resource effort over a time range D and for a skill set E (representing, perhaps, XML programmers). Each of these PDO assignments represents a different instance of the same PDO. These PDO assignments can be of different types, and each PDO assignment typically has a different value.

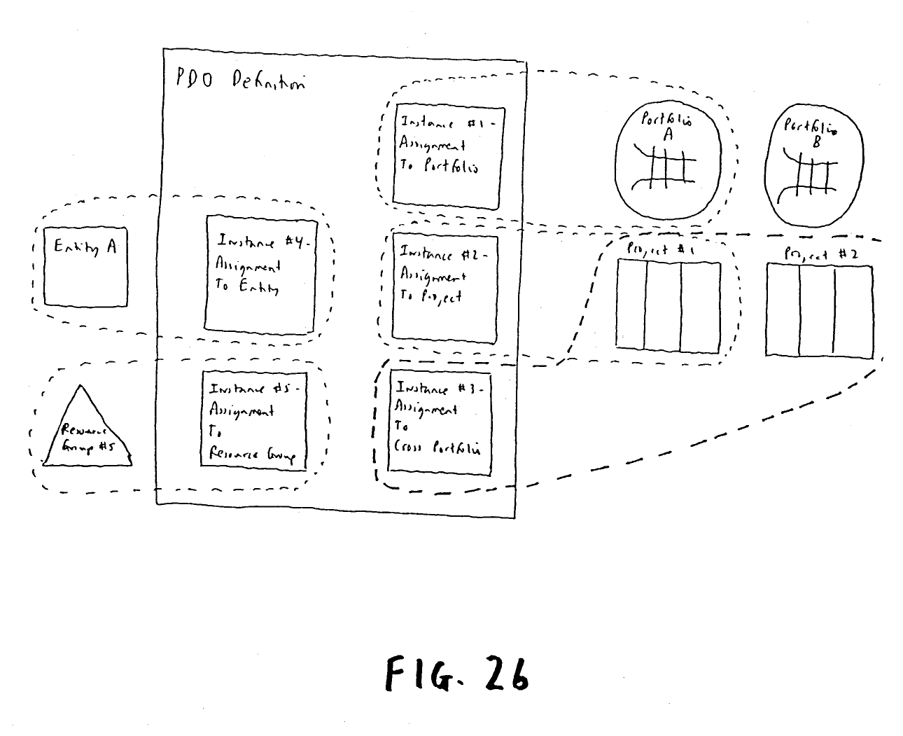

FIG. 26 illustrates how a single PDO can be assigned, through the use of multiple assignments, to more than one system element. However, it should be recalled that a given system element may only have one PDO assignment for a given PDO.

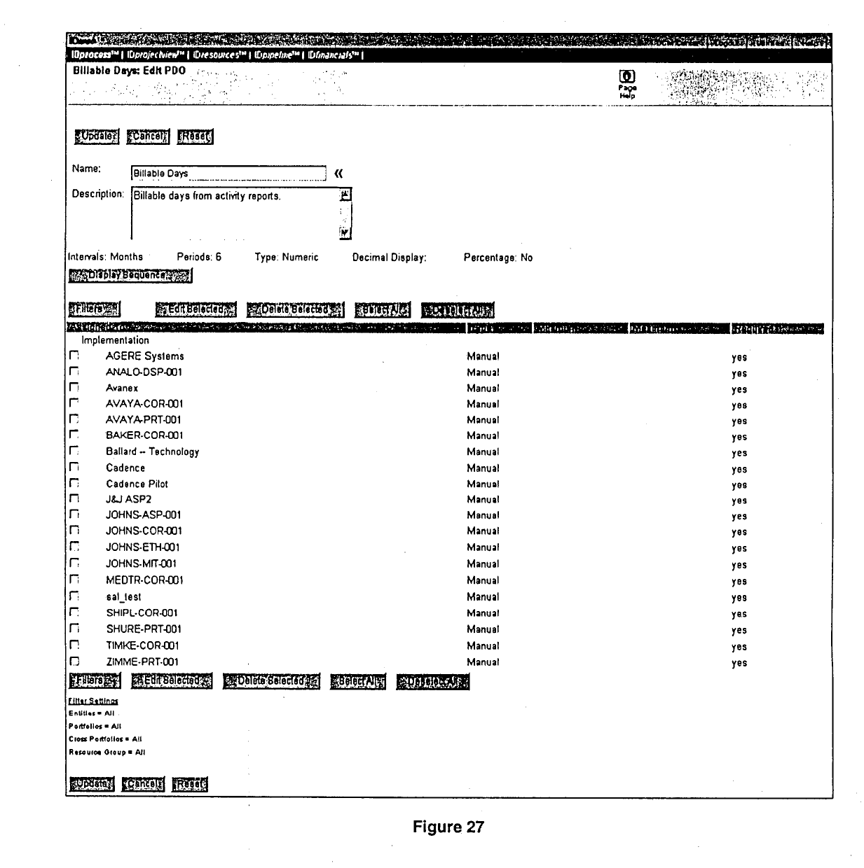

FIG. 27 is a screen display illustrating how a single PDO may be assigned to more than one system element.

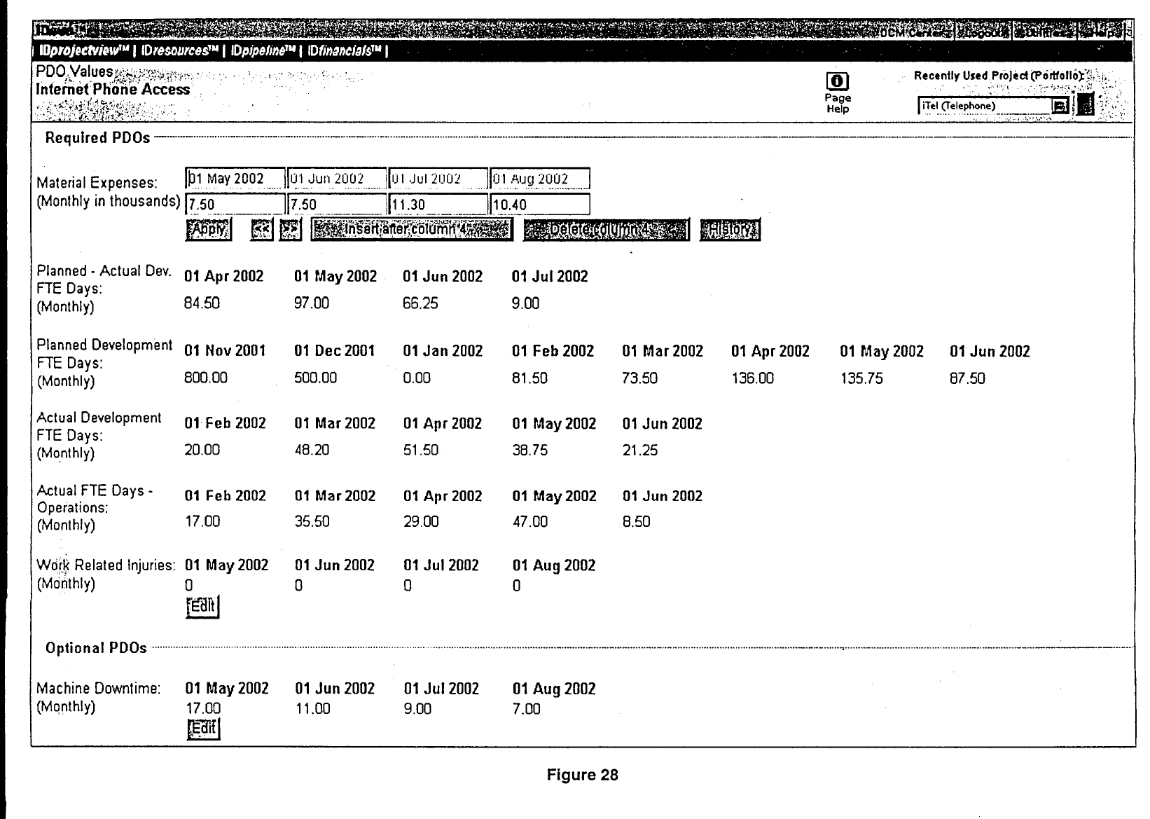

FIG. 28 is a screen display illustrating how a single system element can have more than one PDO assigned to it.

Data Population

Once a PDO has been created and assigned, in the case of a manual PDO assignment, the “owner” of the system element to which the PDO is assigned (e.g., a project manager, where the PDO is assigned to a project) has the responsibility for ensuring that the proper data is entered into the system (which data will then pass through to the PDO assignment).

In the case of a calculated PDO assignment, the formula of the PDO assignment determines the source(s) of the data which will be automatically aggregated in the PDO assignment. Furthermore, it should be appreciated that calculated PDO assignments take place in real time, so any change to a PDO assignment referenced by a formula in a calculated PDO assignment will immediately impact the calculated PDO assignment.

In the case of an FTE PDO assignment, the PDO assignment identifies the specific project which is the source of the data and then automatically extracts the data from that project.

In the case of a cost FTE PDO assignment, data is captured in the same manner as an FTE PDO assignment and then multiplied by a cost so as to derive the resource cost.

Data Mining

Inasmuch as PDO's can be selectively assigned to a wide range of different system elements (e.g., projects or project elements, portfolios, cross portfolios, entities and resource groups), it is possible to capture and aggregate data in ways not previously possible.

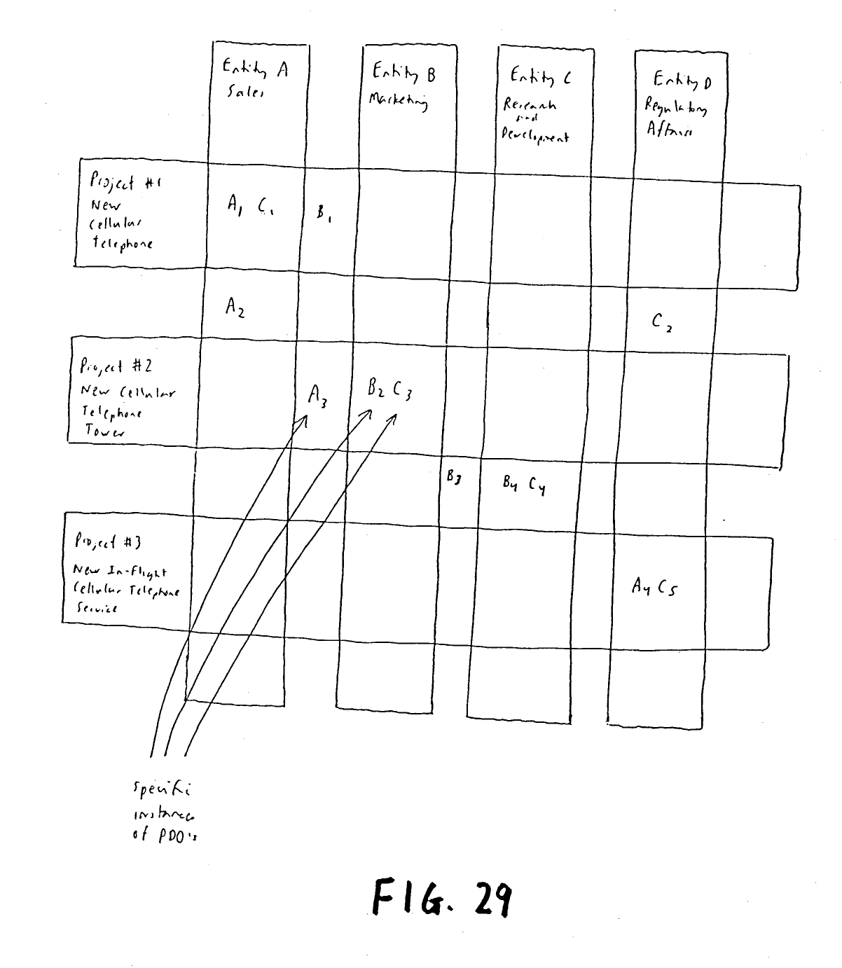

For example, and looking now at FIG. 29, there is shown a simple two dimensional matrix where projects are listed horizontally and different organizational entities are listed vertically. Multiple PDO's (A, B, C, etc.) with multiple PDO assignments (A₁, A₂, A₃, A₄; B₁, B₂, B₃, B₄; C₁, C₂, C₃, C₄, C₅; etc.) of different types can be aggregated along any axis. Thus, information can be derived on a project basis, by aggregating horizontally, or on an entity basis, by aggregating vertically. Significantly, since an entity can be representative of any organizational grouping, PDO assignments make it possible to extract relevant data on the basis of any organizational group.

By way of example, a particular business may have specific organizational structure. This specific organizational structure can be represented by appropriately defining a group of entities. Through the creation of appropriate PDO's and PDO assignments, data can be captured at any level within the organization, e.g., horizontally by project or vertically by entity, and reported at any level of detail. Significantly, this data may be aggregated vertically, “along the stovepipe”, whereby to report data by entity.

### Third Addendum

In one preferred implementation of the present invention, Product Data Objects (PDO's) are embodied in software developed by Integrated Development Enterprise of Concord, Massachusetts under the name IDfinancials.

Further details regarding PDO's are disclosed in the product brochure for IDfinancials™ (entitled “Idfinancials for product development FINANCIAL MANAGEMENT FOR THE DEVELOPMENT CHAIN”), a copy of which is attached as APPENDIX L, and in a collection of pages entitled “ADDITIONAL SHEETS III”, a copy of which is attached as APPENDIX M.

### Managed Parents

As noted above, and returning now to FIG. 3, a specific project 40 can be viewed, schematically, as consisting of a structured development process 47 consisting of one or more phases 50, plus the strategic data (or “metrics”) associated with that project, plus the resources needed to implement that project.

The project's phases 50 may also include a plurality of subordinate steps 55, each of which may include one or more subordinate tasks 60, etc.

As also noted above, and returning now to FIG. 10, the system's architecture is such that all of the projects 40 in a given portfolio 35 must conform to the criteria specified for that portfolio by the process planning and management component 25. Thus, there is a process hierarchy, with each of the projects 40 residing “below” a “parent” portfolio 35 and inheriting from that parent portfolio the specific criteria which is to be tracked for each project in the portfolio. Furthermore, portfolios can have their own hierarchy, i.e., two or more portfolios 35 can themselves be associated with another portfolio, e.g., a superportfolio 110, wherein the portfolios 35 inherit their tracking criteria from the superportfolio 110 and then, in turn, impose that tracking criteria on all of the projects 40 below them.

In other words, as shown in FIG. 10, as a consequence of the system's architecture, there is a hierarchy from superportfolio to portfolio to projects, etc., with each element in the system inheriting the tracking criteria imposed on it by the element immediately above it.

As also noted above, and looking now at FIG. 11, the use of a common standard among all of the projects in a portfolio is a powerful tool, since it allows data to be accurately and reliably aggregated upward from the project level to the portfolio level.

Among other things, data can be aggregated upwardly from tasks to steps to phases to projects, etc.

Thus it will be seen that just as a “child” element (or “child”) residing below a “parent” element (or “parent”) inherits tracking criteria from the parent, so too the parent inherits data from its children. This concept of the parent inheriting data from its children is sometimes referred to as a “rolled-up” parent.

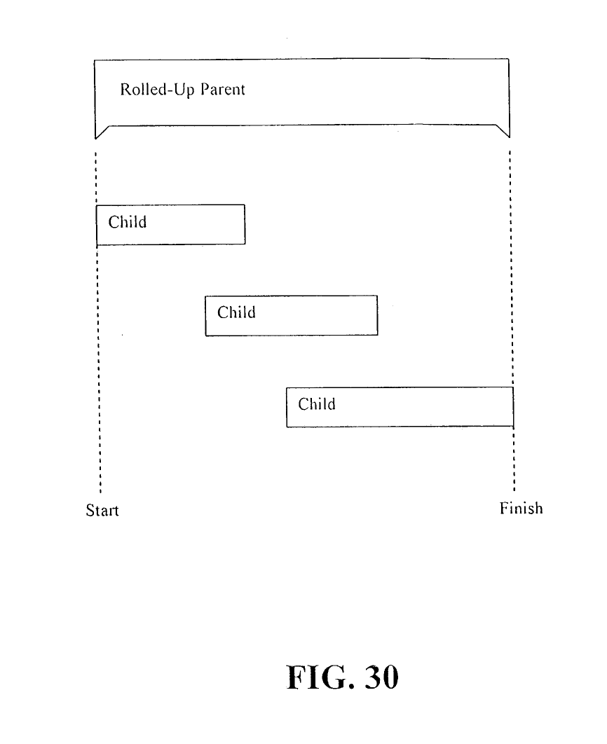

Thus, for example, in FIG. 30 there is shown a rolled-up parent which has three children. The rolled-up parent may be a project, phase, step or task, and the children may be any elements subordinate to that parent. The rolled-up parent is typically characterized by a start time and a finish time. The start time for the rolled-up parent is set by the earliest of (i) the start time for the rolled-up parent, or (ii) the earliest start time for any of the children. The finish time for the rolled-up parent is set by the latest of (i) the finish time for the parent, or (ii) the latest finish time for any of the children.

More particularly, in the usual sequence, the rolled-up parent is first created, and this initially sets the start time and the finish time for the rolled-up parent. As the children are thereafter created, if any of the children starts earlier than the rolled-up parent's start time, the rolled-up parent's start time is moved up accordingly. Similarly, as the children are created, if any of the children finishes later than the rolled-up parent's finish time, the parent's finish time is moved back accordingly.

Similarly, if any of the childrens' lengths are thereafter adjusted so as to extend beyond the length of the rolled-up parent, the start time and/or the finish time of the rolled-up parent is adjusted correspondingly.

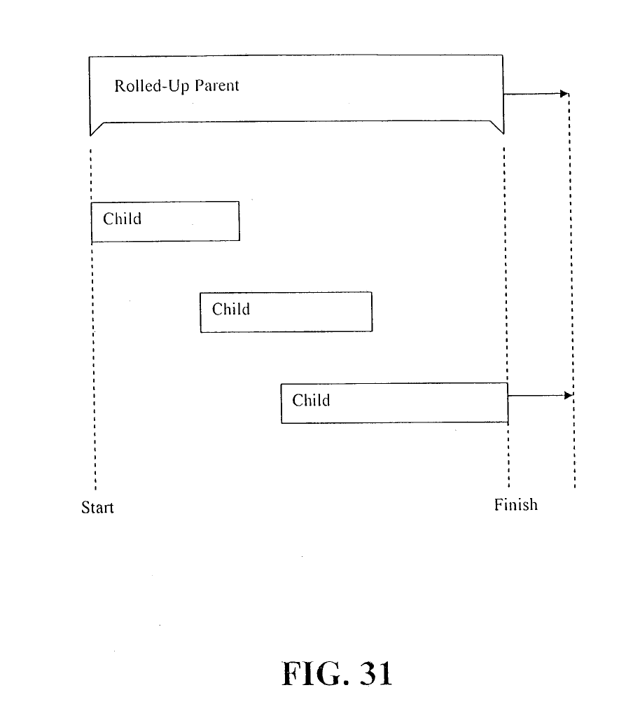

See FIG. 31.

Thus it will be appreciated that with rolled-up parents, (i) all children must be within the boundaries of the rolled-up parent, and (ii) if any of the children extend beyond the boundaries of the rolled-up parent, the rolled-up parent must widen so as to accommodate all of the children. This is true for both the initial creation of the children and for any changes occurring during the life of the project.

One consequence of the rolled-up parent construct is that the rolled-up parent is essentially something of a slave to its children, lengthening and/or shortening according to the concatenation of its children. However, this also means that the manager of the higher level parent is always subject to the dictates of the manager of the lower level child. Furthermore, this effect percolates upward throughout the system, so that the manager of the lowest level child can effectively dictate start and end times for the manager of the highest level parent.

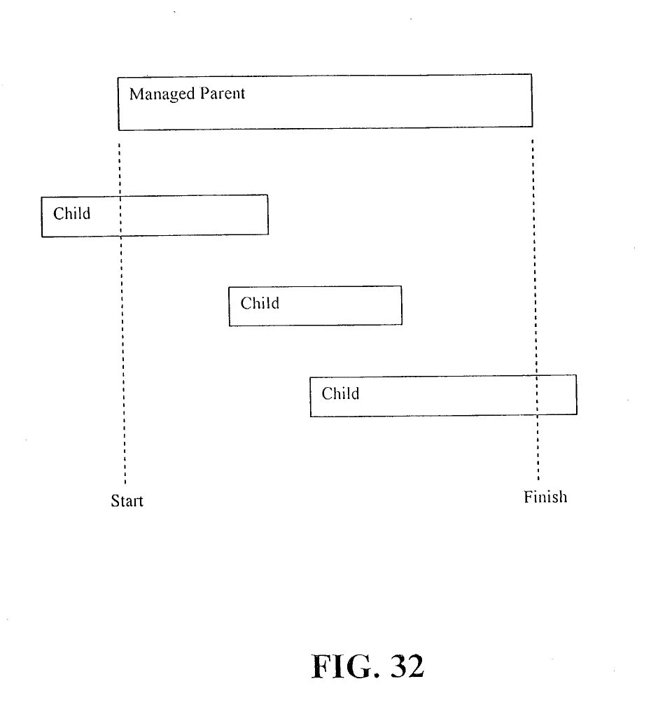

A new construct, known as a “managed” parent, has now been developed to address this issue. More particularly, the managed parent allows the children to extend outside the boundary of the parent. See FIG. 32. This construct permits the parent to reflect the data of its children in the long run, but also allows the children to “stray” in the short run while the managers of the parent and child negotiate a resolution to their different start time and/or finish time. In essence, the managed parent construct permits a temporary de-linkage between the parent and its children, allowing both parent and children to maintain their respective characters while the managers negotiate a resolution to any differences.

The managed parent is constructed so that if the parent is dragged, it will not change the duration of the children; however, if the parent is moved, it will result in the children being moved a corresponding amount.

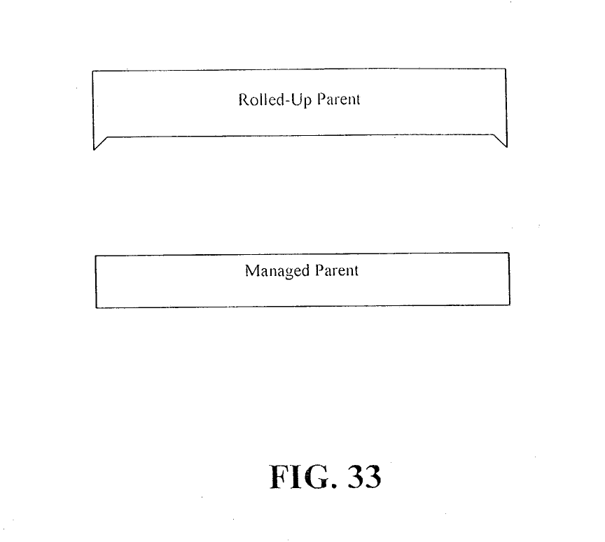

Rolled-up parents and managed parents may coexist in the same system. To this end, and looking now at FIG. 33, they may be given different visual displays.

In one preferred implementation, the system is initially set up with all of the parents being rolled-up parents, so that the relationship between parents and children is highly visible to the user. Thereafter, the rolled-up parents are changed to managed parents; as a result, variations in the children are prevented from automatically rolling-up into the parent.

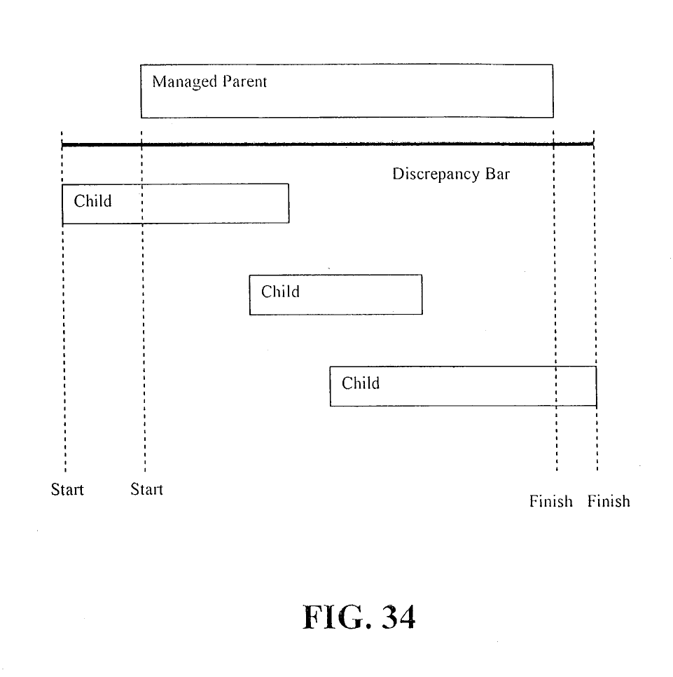

The system is configured to visually display discrepancies between rolled-up and managed parents. More particularly, and looking now at FIG. 34, where there is a discrepancy between rolled-up and managed parents, a discrepancy bar is generated on the display.

The system is also configured so that a parent can be switched back and forth between its rolled-up and managed states.

In one preferred form of the invention, projects and phases are configured so as to default to a managed state relative to their immediate child, and steps and tasks are configured so as to default to a rolled-up state relative to their immediate child. These defaults may, of course, be reset by the user.

There are a number of advantages to providing the managed parent construct.

For one thing, managed parents provide temporary flexibility to the system while discrepancies between parent and child start and end points are addressed by the managers of those elements.

For another thing, managed parents prevent a child from changing the start and finish dates of the parent. This avoids unpleasant last-minute surprises for managers of parents who have failed to notice changes in their children earlier in the project.

Also, where the system uses only rolled-up parents, and where a child causes an elongation of the parent, the manager of the parent may have a difficult time finding out precisely which child has caused that elongation. In particular, as the number of layers in the system increases, the task of finding the errant child increases dramatically. With the use of discrepancy bars, locating the errant child is rendered relatively easy: the manager of the managed parent only needs to follow down the hierarchy, looking for the presence of the lowest discrepancy bar—once the lowest discrepancy bar has been located, the errant child will lie immediately below that discrepancy bar.

### Start and Finish Constraints, Anchored Elements, Dependencies and Float

(i) Start and Finish Constraints.

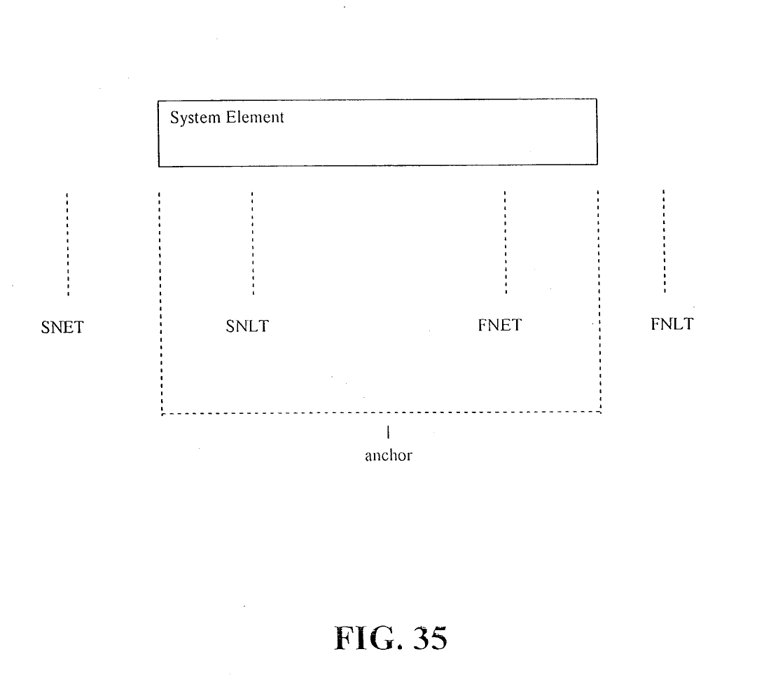

Looking next at FIG. 35, there is shown a system element. This system element may be a project, phase, step or task; and it may be a rolled-up parent, a managed parent and/or a child. Regardless of its type, the system element may be subject to certain start and finish constraints, i.e., a “start no earlier than” (“SNET”) time constraint, a “start no later than” (“SNLT”) time constraint, a “finish no earlier than” (“FNET”) time constraint, or a “finish no later than” (“FNLT”) time constraint.

In accordance with one feature of the present invention, the system is configured so that a user is free to manually set anywhere from one to four of the aforementioned start and finish constraints for the system element, i.e., the system is configured so that a user is free to manually set anywhere from one to four of the SNET, SNLT, FNET and FNLT constraints for each system element. Thus, depending on which ones of these start and/or finish constraints may be set, the system element may have its start and/or finish points appropriately restricted. While such start and/or finish constraints are in effect, these restrictions may prevent the system element from moving beyond the constraint, either through direct modification or through indirect modification (i.e., by modification of a rolled-up parent through modification of an underlying child). More particularly, the system is preferably configured as follows: (i) in the case of direct modification, the user is warned of a violation of a start and/or finish constraint and provided with the opportunity to violate or honor the date constraint; and (ii) in the case of indirect modification, the system's default behavior is to honor date constraints but the user has the option to change this default behavior so that the date constraints are violated.

(ii) Anchored Elements.

Furthermore, in accordance with another feature of the present invention, the system is configured so that where the system element is a managed parent or a child, but not a rolled-up parent, a user may manually anchor the system element, i.e., the system is configured so that a user may manually set the start and finish dates for the system element. Thus, the system element will have its start and finish points appropriately restricted. While this anchor is in effect, the system element will be correspondingly prohibited from moving.

The system is configured so that start and finish constraints (i.e., SNET, SNLT, FNET and FNLT time constraints) and anchors differ in several significant ways.

For one thing, the system is configured so that any user may set start and/or finish constraints for a system element, whereas only the “owner” (i.e., manager) of a system element may set the anchor for that system element.

For another thing, the four start and finish constraints may be set individually, whereas the anchor always requires that both the start and finish dates be locked.

In this respect it should be noted that where a managed parent has been anchored and an underlying child is modified so as to move outside the range of the anchored parent, the anchored parent will not move: instead, a discrepancy bar will be generated to show an inconsistency between parent and child.

It should also be noted that start and finish constraints cannot be used to create the exact equivalent of an anchor. By way of example, suppose the SNET and SNLT time constraints are set to the start date of the system element, and the FNET and FNLT time constraints are set to the finish date of the system element; this is not the exact equivalent of setting an anchor for that system element. This is because (1) any user can set the SNET, SNLT, FNET and FNLT time constraints, but only the owner of the system element can set the anchor, (2) any user can allow the system element to exceed the SNET, SNLT, FNET, and FNLT time constraints, whereas this is strictly prohibited with an anchor, and (3) if the system element is dependent on a child and the child moves, the SNET, SNLT, FNET and FNLT time constraints will not prevent corresponding movement of the system element, whereas an anchor will prevent movement of the system element.

(iii) Dependencies and Float.

Various types of dependencies can exist between system elements. More particularly, in many cases the beginning or end of one action is dependent on the beginning or end of another action.

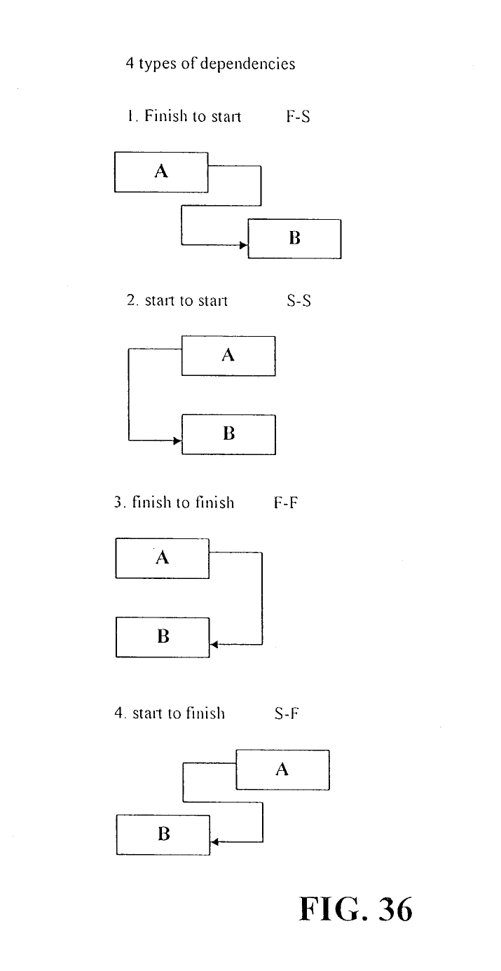

Looking next at FIG. 36, there are shown four types of dependencies which can exist between system elements:

(1) finish-to-start (“F-S”): the start of one action is dependent on the finish of another action;

(2) start-to-start (“S-S”): the start of one action is dependent on the start of another action;

(3) finish-to-finish (“F-F”): the finish of one action is dependent on the finish of another action; and

(4) start-to-finish (“S-F”): the finish of one action is dependent on the start of another action.

In some cases there may some flexibility between the beginning or end of one action and the beginning or end of another project. This flexibility is sometimes referred to as “float”.

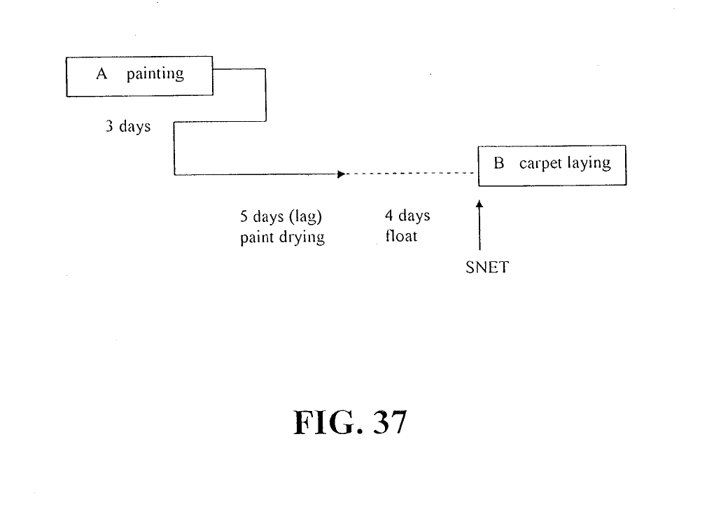

By way of example, and looking next at FIG. 37, there is shown a typical finish-to-start dependency. Here action B (carpet laying) cannot begin until action A (painting) has been completed. In addition, there is a delay period while the paint dries.

There may also be a “float”. In other words, there may be some flexibility between the time when the paint is finished drying and the time when carpet laying must begin.

In accordance with a further feature of the invention, the system is configured to provide the user with a visual indication of this float.

### Fourth Addendum

In one preferred implementation of the present invention, start and finish constraints, anchored elements, dependencies and float are embodied in software developed by Integrated Development Enterprise of Concord, Massachusetts.

Further details regarding start and finish constraints, anchored elements, dependencies and float are disclosed in Date Constraints, Parent/Child Relationships and Dependencies in a Nutshell, a copy of which is attached as Appendix N; Date Constraints, Parent/Child Relationships and Dependencies in a Nutshell—Addendum, a copy of which is attached as Appendix 0; Functional Design—Gantt Chart, a copy of which is attached as Appendix P; Critical Path in a Peapod, a copy of which is attached as Appendix Q; and/or Date and Status Logic in a Clamshell, a copy of which is attached as Appendix R.

What is claimed is:

1. A computer program product embodied on a computer-readable medium and comprising code that, when executed, causes the computer to perform the following:
a configuration of a structured system for the planning, integration, analysis and management of new product development on a real-time, enterprise-wide basis at the initiation of said computer code, said system comprising:
a portfolio planning and management component;
a project planning and management component;
a resource planning and management component;
a process planning and management component; and
a managed parent construct defining a flexible relationship between parent data and child data in at least one of said components;
a modification of said child data in one of said components; and
an automatic reconfiguration of each of said other components to conform with said modified one of said components without automatic modification to said parent data.

2. A computer program according to claim 1 further comprising a visual display for indicating discrepancies between parent data and child data.

3. A computer program according to claim 1 further comprising a rolled-up parent construct defining a linked relationship between said parent data and said child data in at least one of said components so as to permit an automatic reconfiguration of each of said other components to conform to said modified one of said components with automatic modification to said parent data within said rolled-up parent construct

4. A computer program according to claim 3 further comprising a selectively configurable parent construct configured to be switched between said managed parent construct and said rolled-up parent construct.

5. A computer program product embodied on a computer-readable medium and comprising code that, when executed, causes the computer to perform the following:
a configuration of a structured system for the planning, integration, analysis and management of new product development on a real-time, enterprise-wide basis at the initiation of said computer code, said system comprising:
a portfolio planning and management component;
a project planning and management component;
a resource planning and management component; and
a constraint construct selectively defining at least one of a start constraint and a finish constraint for a system element of at least one of said components;
a modification of one of said components without automatic modification of the system element beyond said start constraint and said finish constraint; and
an automatic reconfiguration of each of said other components without automatic modification of the system element beyond said start constraint and said finish constraint.

6. A computer program according to claim 5 further comprising a warning display for indicating a violation of one of said start constraint and said finish constraint for said system element by said modification of one of said components and said automatic reconfiguration of each of said other components.

7. A computer program according to claim 5 wherein said start constraint comprises a start of said system element no earlier than a first given time constraint and a start of said system element no later than a second given time constraint.

8. A computer program according to claim 5 wherein said finish time constraint comprises a finish of said system element no earlier than a third given time constraint and a finish of said system element no later than a fourth given time constraint.

9. A computer program product embodied on a computer-readable medium and comprising code that, when executed, causes the computer to perform the following:
a configuration of a structured system for the planning, integration, analysis and management of new product development on a real-time, enterprise-wide basis at the initiation of said computer code, said system comprising:
a portfolio planning and management component;
a project planning and management component;
a resource planning and management component;
a process planning and management component; and
an anchored element construct defining a disconnected relationship between parent data and child data in at least one of the components, a system element comprising at least a portion of one of said parent data and said child data in at least one of the components, and selectively configurable restriction parameters for setting a given start time and a given finish time for said system element;
a modification of at least one of said components; and
an automatic reconfiguration of each of said other components to conform with said modified one of said components without automatic modification to said anchored system element.

10. A computer program according to claim 9 wherein said anchored system element is prohibited from being moved by any user except for an owner of said anchored system element.

11. A computer program according to claim 9 wherein said anchored system element is prohibited from being moved based on movement of said child data corresponding thereto.

12. A computer program product embodied on a computer-readable medium and comprising code that, when executed, causes the computer to perform the following:
a configuration of a structured system for the planning, integration, analysis and management of new product development on a real-time, enterprise-wide basis at the initiation of said computer code, said system comprising:
a portfolio planning and management component;
a project planning and management component;
a resource planning and management component;
a process planning and management component; and
a dependent system element structure, wherein at least a given start time and a given end time of an action of a first system element in at least one of said components is dependent on at least one of a given start time and a given end time of another action of a second system element in at least one of said components;
a modification of one of said components; and
an automatic reconfiguration of each of said other components to conform with said modified one of said components, and an automatic reconfiguration of said action of said first system element to conform with said another action of said second system element.

13. A computer program product according to claim 12 wherein said given start time of said action of said first system element is dependent on said end time of said another action of said second system element.

14. A computer program product according to claim 12 wherein said given end time of said action of said first system element is dependent on said given end time of said another action of said second system element.

15. A computer program product according to claim 12 wherein said given start time of said action of said first system element is dependent on said given start time of said another action of said second system element.

16. A computer program product according to claim 12 wherein said given end time of said action of said first system element is dependent on said given start time of said another action of said second system element.

17. A computer program product according to claim 12 further comprising a float period between said action of said first system element and said another action of said second system element.

18. A computer program product according to claim 17 further comprising a visual indicator representing said float period.
